(19) United States
(12) Patent Application Publication
(10) Pub. No.: US 2007/0286500 A1
(43) Pub. Date: Dec. 13, 2007

(54) Image encoding method and image encoding apparatus

(76) Inventors: Kozo Akiyoshi, Tokyo (JP); Nobuo Akiyoshi, Tokyo (JP)

Correspondence Address: Ralph A. Dowell of DOWELL & DOWELL P.C., 2111 Eisenhower Ave, Suite 406, Alexandria, VA, 22314, US

(21) Appl. No.: 11/802,565

(22) Filed: May 23, 2007

(30) Foreign Application Priority Data
May 23, 2006 (JP) 2006-142361

(51) Int. Cl. G06K 9/36

(52) U.S. Cl. 382/232

(57) ABSTRACT

An image input unit in a producer PC acquires a first key frame formed as a single image comprising an arrangement of a plurality of still images, and a second key frame formed as a single image comprising an arrangement of a plurality of still images respectively corresponding in position to the plurality of still images in the first key frame. A matching processor acquires corresponding point information related to corresponding points in the first key frame and the second key frame by subjecting the frames to an image matching process. A stream generation unit outputs the first key frame, the second key frame and the corresponding point information as encoded data.

### BACKGROUND OF THE INVENTION

1. Field of the Invention

The present invention relates to an image encoding technology and, more particularly, to a digital image encoding method and a digital image encoding apparatus.

2. Description of the Related Art

The Internet. has become widely accepted in society in general. Corporations and individuals publish on the Internet web pages that they produce. Users of personal computers (PCs) and cell phones access their web pages and view various images including still images and moving images at their ease. In producing web pages that include images, corporations and individuals may carry a plurality of images on the same web page. For example, corporations engaging in e-commerce transactions via the Internet often carry the images of a plurality of products that they deal with on the same web page. Meanwhile, the development of a technology related to image matching process as described in patent document No. 1 is being undertaken. Such a technology may be utilized to show animation on a web page.

[Patent document No. 1]

JP 10-269355

Image matching process involves computing matching between a plurality of images. Even in a case where a single piece of animation is displayed, a plurality of images are therefore necessary. Therefore, when a matching process is utilized to display a plurality of pieces of animation on the same web page, a plurality of images subject to a matching process have to be produced for each piece of animation displayed. A detailed description will be given with reference to FIGS. 25A and 25B.

It is assumed that an animation is displayed on the same web page by computing matching between a plurality of still images shown in FIG. 25A and a plurality of still images shown in FIG. 25B. The a plurality of still images shown in FIG. 25A include a first key frame 62, a second key frame 63 and a third key frame 64. These key frames are formed as rectangles of the same shape and size. The first key frame 62 is formed as a first image 68, which is a single still image representing a flower bud. The second key frame 63 is formed as a second image 69, which is a single still image representing an airplane in the lower right. The third key frame 64 is formed a third image 70, which is a single still image representing an automobile in the right.

The plurality of still images shown in FIG. 25B include a fourth key frame 65, a fifth key frame 66 and a sixth key frame 67. These key frames are formed as rectangles of the same shape and size. The fourth key frame 65 is formed as a fourth image 71, which is a still image representing a flower in bloom. The fifth key frame 66 is formed as a fifth image 72, which is a single still image representing an air plane in the middle. The sixth key frame 67 is formed as a sixth image 73, which is a single still image representing an automobile in the left.

In the example illustrated in FIG. 25A, the first key frame 62, the second key frame 63 and the third key frame 64 are arranged on the same web page. In the example illustrated in FIG. 25B, the fourth key frame 65, the fifth key frame 66 and the sixth key frame 67 are arranged on the same web page. By performing a matching process, an animation is displayed on the web page, showing the flower coming into bloom gradually, with the first key frame 62 being defined as a source image and the fourth key frame 65 being defined as a destination image. Another animation is displayed on the web page, showing the airplane flying higher and higher, with the second key frame 63 being defined as a source image and the fifth key frame 66 being defined as a destination image. Yet another animation is displayed on the web page, showing the automobile running from right to left, with the third key frame 64 being defined as a source image and the sixth key frame 67 being defined as a destination image.

Ir. the example given above, key frame to key frame matching is computed for each of three pairs of key frames. As illustrated, computing key frame to key frame matching for a plurality of pairs of key frames requires the number of key frames at least twice as large as the number of pairs. Accordingly, time and labor required to produce key frames would be enormous. Further, a heavy load is incurred in the apparatus in computing key frame to key frame matching for each of a plurality of pairs of key frames.

### SUMMARY OF THE INVENTION

In this background, a general purpose of the present invention is to facilitate the production of a combination of images subject to a matching process and to reduce the load on the apparatus for performing a matching process.

The image encoding method according to at least one embodiment of the present invention comprises the following steps:

(1) acquiring a first key frame formed as a single image comprising an arrangement of a plurality of still images, and a second key frame formed as a single image comprising an arrangement of a plurality of still images respectively corresponding in position to the plurality of still images in the first key frame;

(2) acquiring corresponding point information related to corresponding points in the first key frame and the second key frame by subjecting the frames to an image matching process; and

(3) outputting the first key frame, the second key frame and the corresponding point information as encoded data.

By displaying animation between key frames by subjecting the first key frame and the second key frame to a matching process according to this embodiment, the same visual effect as provided by computing key frame to key frame matching for a plurality of pairs of key frames respectively can be delivered. This facilitates the production of key frames by the producer. The technology (hereinafter, referred to as “base technology”) proposed in Japanese Patent No. 2927350 commonly owned by the assignee of the present patent application would be suitably used as the image matching process mentioned above.

A predetermined image separation area may be provided between the plurality of still images included in each of the first and second key frames. The predetermined image separation area may be provided at the periphery of each of the still images arranged. The image separation area may constitute a background area for the plurality of still images.

A dominant pixel value in the background area may differ from each of dominant pixel values in a predetermined area in each of the plurality of still images placed in the background area, by a predetermined threshold or more. The pixel value in this case may be any value such as an average (mode, median) or a mode value which characterizes an image. The image encoding method may further comprise the process of recording the subjecting as a basis for a single billing process.

It is to be noted that the base technology is not indispensable for the present invention. Moreover, any arbitrary replacement or substitution of the above-described structural components and the steps, expressions replaced or substituted in part or whole between a method and an apparatus as well as addition thereof, and expressions changed to a computer program, recording medium or the like are all effective as and encompassed by the present embodiments.

### BRIEF DESCRIPTION OF THE DRAWINGS

FIG. 1a is an image obtained as a result of the application of an averaging filter to a human facial image.

FIG. 1b is an image obtained as a result of the application of an averaging filter to another human facial image.

FIG. 1c is an image of a human face at p^{(5,0)} obtained in a preferred embodiment in the base technology.

FIG. 1d is another image of a human face at p^{(5,0)} obtained in a preferred embodiment in the base technology.

FIG. 1e is an image of a human face at p obtained in a preferred embodiment in the base technology.

FIG. 1f is another image of a human face at p^{(5,1)} obtained in a preferred embodiment in the base technology.

FIG. 1g is an image of a human face at p^{(5,2)} obtained in a preferred embodiment in the base technology.

FIG. 1h is another image of a human face at p^{(5,2)} obtained in a preferred embodiment in the base technology.

FIG. 1i is an image of a human face at p^{(5,3)} obtained in a preferred embodiment in the base technology.

FIG. 1j is another image of a human face at p^{(5,3)} obtained in a preferred embodiment in the base technology.

FIG. 2R shows an original quadrilateral.

FIG. 2A shows an inherited quadrilateral.

FIG. 2B shows an inherited quadrilateral.

FIG. 2C shows an inherited quadrilateral.

FIG. 2D shows an inherited quadrilateral.

FIG. 2E shows an inherited quadrilateral.

FIG. 3 is a diagram showing the relationship between a source image and a destination image and that between the m-th level and the (m−1)th level, using a quadrilateral.

FIG. 4 shows the relationship between a parameter η (represented by x-axis) and energy C_{f} (represented by y-axis).

FIG. 5a is a diagram illustrating determination of whether or not the mapping for a certain point satisfies the bijectivity condition through the outer product computation.

FIG. 5b is a diagram illustrating determination of whether or not the mapping for a certain point satisfies the bijectivity condition through the outer product computation.

FIG. 6 is a flowchart of the entire procedure of a preferred embodiment in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source hierarchical images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 12.

FIG. 16 is a graph showing the behavior of energy C_{f}^{(m,s)} corresponding to f^{(m, s)} (λ=iΔλ) which has been obtained for a certain f^{(m, s)} while varying λ.

FIG. 17 is a diagram showing the behavior of energy C_{f}⁽ⁿ⁾ corresponding to f⁽ⁿ⁾ (η=iΔη)(i=0, 1, . . . ) which has been obtained while varying η.

FIG. 18 shows the overall structure of an example of an image processing system 10.

FIG. 19 is a functional block diagram of a producer PC according to a first embodiment.

FIG. 20A shows a key frame form.

FIG. 20B shows a seventh key frame formed as a source image.

FIG. 20C shows an eighth key frame formed as a destination image.

FIG. 21 is a functional block diagram of a server according to the first embodiment.

FIG. 22 is a functional block diagram of a viewer PC according to the first embodiment.

FIG. 23 is a functional block diagram of a server according to a second embodiment.

FIG. 24A shows a ninth key frame formed as a source image.

FIG. 24B shows a tenth key frame formed as a destination image.

FIG. 25A shows first through third key frames formed as source images.

FIG. 25B shows fourth through sixth key frames formed as destination images.

### DETAILED DESCRIPTION OF THE INVENTION

The invention will now be described by reference to the preferred embodiments. This does not intend to limit the scope of the present invention, but to exemplify the invention.

At first, the multiresolutional critical point filter technology and the image matching processing using the technology, both of which will be utilized in the preferred embodiments, will be described in detail as “Base Technology”. These techniques are patented under Japanese Patent No. 2927350 and owned by the same assignee of the present invention, and they realize an optimal achievement when combined with the present invention. This is because, by using the matching technology such as that of the base technology, it is possible to generate an intermediate image of key frames as a whole as if images are formed between correspondingly positioned ones of a plurality of still images placed in the key frames. However, it is to be noted that the image matching techniques which can be adopted in the present embodiments are not limited to this.

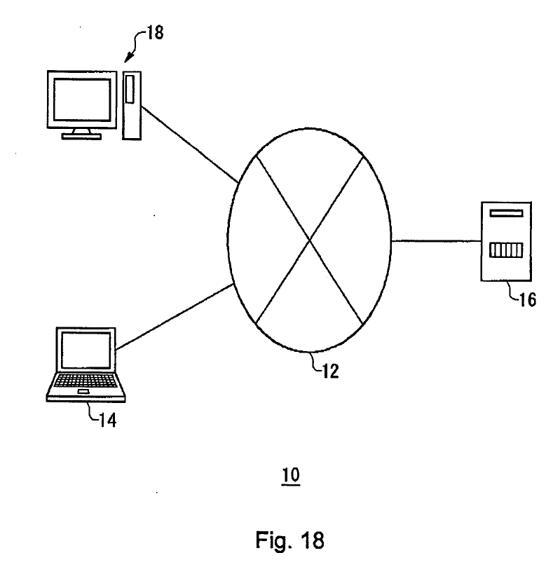

A specific description of the image processing technology using the base technology will be given with reference to FIG. 18 and subsequent figures.

### Background of the Base Technology

Automatic matching of two images, that is, correspondence between image regions or pixels, has been one of the most important and difficult themes of computer vision and computer graphics. For instance, once the images of an object from different view angles are matched, they can be used as the base for generating other views. When the matching of right-eye and left-eye images is computed, the result can immediately be used for stereo photogrammetry. When a model facial image is matched with another facial image, it can be used to extract characteristic facial parts such as the eyes, the nose, and the mouth. When two images of, for example, a man and a cat are matched exactly, all the in-between images can be generated and hence morphing can be done fully automatically.

However, in the existing methods, the correspondence of the points of the two images must generally be specified manually, which is a tedious process. In order to solve this problem, various methods for automatically detecting correspondence of points have been proposed. For instance, application of an epipolar line has been suggested to reduce the number of candidate pairs of points, but the complexity is high. To reduce the complexity, the coordinate values of a point in the left-eye image are usually assumed to be close to those of the corresponding point in the right-eye image. Providing such restriction, however, makes it very difficult to simultaneously match global and local characteristics.

In volume rendering, a series of cross-sectional images are used for constituting voxels. In such a case, conventionally, it is assumed that a pixel in the upper cross-sectional image correspond to the pixel that occupies the same position in the lower cross section, and this pair of pixels is used for the interpolation. Using this very simple method, volume rendering tends to suffer from unclear reconstruction of objects when the distance between consecutive cross sections is long and the shape of the cross sections of the objects thus changes widely.

A great number of image matching algorithms such as the stereo photogrammetry methods use edge detection. In such a method, however, the resulting matched pairs of points are sparse. To fill the gaps between the matched points, the disparity values are interpolated. In general, all edge detectors suffer from the problem of judging whether a change in the pixel intensity in a local window they use really suggests the existence of an edge. These edge detectors suffer from noises because all edge detectors are high pass filters by nature and hence detect noises at the same time.

Optical flow is another known method. Given two images, optical flow detects the motion of objects (rigid bodies) in the images. It assumes that the intensity of each pixel of the objects does not change and computes the motion vector (u, v) of each pixel together with some additional conditions such as the smoothness of the vector field of (u, v). Optical flow, however, cannot detect the global correspondence between images because it concerns only the local change of pixel intensity and systematic errors are conspicuous when the displacements are large.

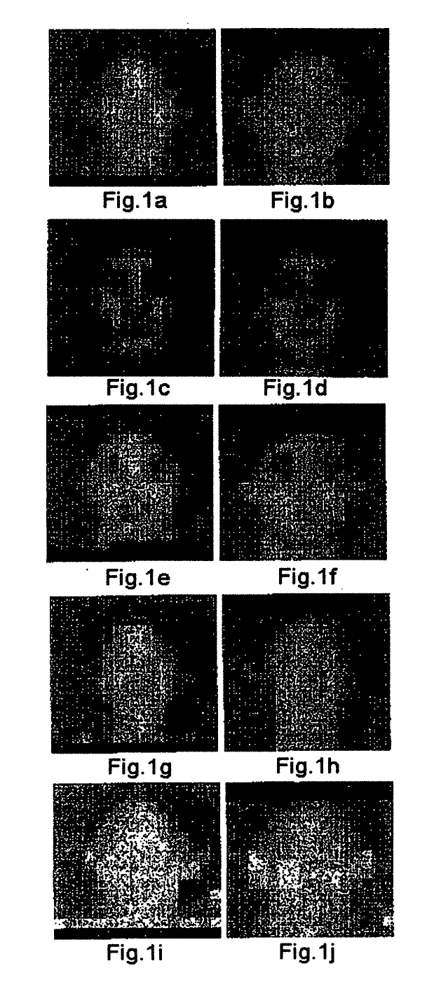

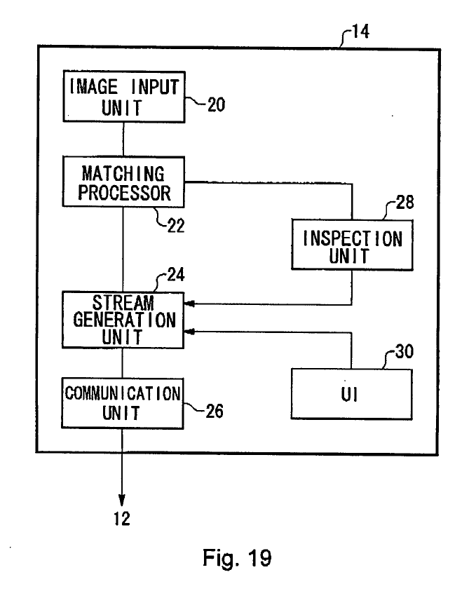

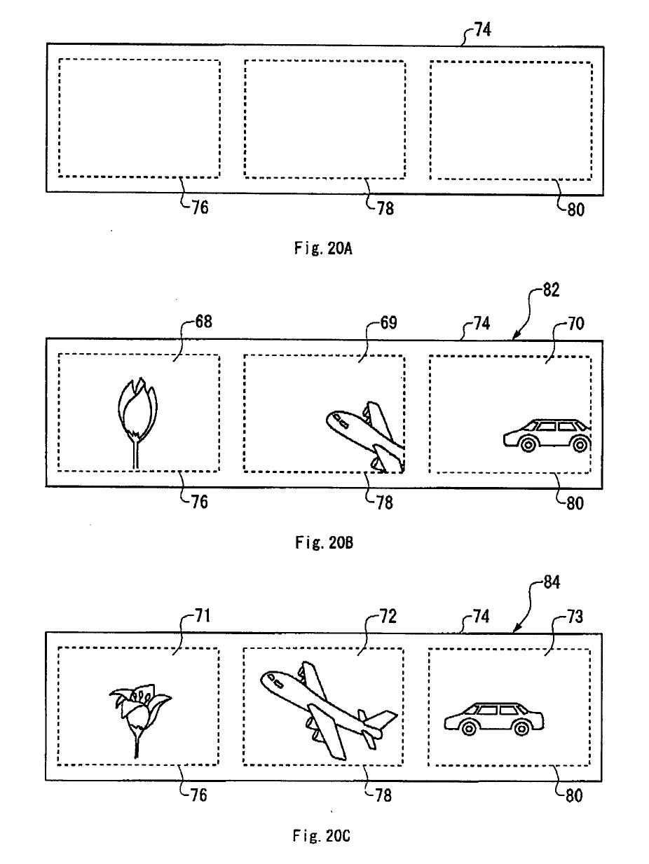

To recognize the global structures, a great number of multiresolutional filters have been proposed. They are classified into two groups: linear filters and nonlinear filters. An example of the former is a wavelet. However, the linear filters are not useful when used for image matching, because the information of the pixel intensity of extrema as well as their locations are blurred. FIGS. 1(a) and 1(b) show the result of the application of an averaging filter to the facial images in FIGS. 19(a) and 19(b), respectively. FIGS. 1(k)-1(l) show the results of the application of the scaling function of the Battle-Lemarie wavelet to the same facial images. As shown in these drawings, the pixel intensity of extrema is reduced through averaging while the locations are undesirably shifted due to the influence of averaging. As a result, the information of the locations of the eyes (minima of the intensity) is ambiguous at this coarse level of resolution and hence it is impossible to compute the correct matching at this level of resolution. Therefore, although a coarse level is prepared for the purpose of global matching, the obtained global matching does not correctly match the true characteristics of the images (eyes, i.e., the minima) correctly. Even when the eyes appear clearly at the finer level of resolution, it is too late to take back the errors introduced in the global matching. By smoothing the input images, stereo information in textured regions is also filtered out as pointed out.

On the other hand, 1D sieve operators have become available as nonlinear filters which can be used for morphological operations. 1D sieve operators smooth out the images while preserving scale-space causality by choosing the minimum (or the maximum) inside a window of a certain size. The resulting image is of the same size as the original, but is simpler because small undulations are removed. Although this operator may be classified as “a multiresolutional filter” in a broad sense that it reduces image information, it is not a multiresolutional filter in a normal sense as it does not put images into hierarchy while changing the resolution of the images as wavelets do. This operator thus cannot be utilized for detection of correspondence between images.

### Problem to be Solved by the Base Technology

In view of the above, the following problems are presented.

1. Image processing methods have rarely been available for accurately identifying the characteristics of an image through relatively simple processing. In particular, effective proposals have been scarcely made in connection with a method for extracting characteristics of an image while preserving information, such as the pixel value or location of a characteristic point.

2. Automatic detection of a corresponding point based on the characteristics of an image generally has had problems including complex processing and low noise durability. In addition, various restrictions have been necessarily imposed in processing, and it has been difficult to obtain a matching which satisfies global and local characteristics at the same time.

3. Although a multiresolutional filter is introduced for recognition of the global structure or characteristics of an image, in the case of a linear filter, information regarding the intensity and location of a pixel becomes blurred. As a result, corresponding points can hardly be recognized with sufficient accuracy. In addition, the 1D sieve operator, which is a non-linear filter, does not hierarchize an image, and cannot be used for detection of a corresponding point between images.

4. With the above problems, extensive manual labor has been inevitably required in processing in order to accurately obtain corresponding points.

The base technology has been conceived to overcome the above problems, and aims to provide techniques for allowing accurate recognition of image characteristics in the image processing field.

### Means Employed by the Base Technology to Solve the Problem

In one aspect of the base technology, a new multiresolutional image filter is proposed. This filter is called a critical point filter as it extracts a critical point from an image. A critical point stands for a point having a certain characteristic in an image, including a maximum, where a pixel value (that is, an arbitrary value for an image or a pixel, such as a color number or the intensity) becomes maximum in a certain region, a minimum, where it becomes minimum, and a saddle point, where it becomes maximum for one direction and minimum for another. A critical point may be based on a topological concept, but it may possess any other characteristics. Selection of criteria for a critical point is not an essential matter in the base technology.

In the above aspect, image processing using a multiresolutional filter is carried out. In a detection step, a two dimensional search is performed on a first image to detect a critical point. In a following generation step, the detected critical point is extracted for generation of a second image having a lower resolution than that of the first image. The second image inherits critical points from the first image. The second image, having a lower resolution than the first image, is preferably used for recognition of global characteristics of an image.

Another aspect of the base technology relates to an image matching method using a critical point filter. In this aspect, source and destination images are matched. The terms a source image” and “a destination image” are determined only for a discriminating purpose, and there is no essential difference between them.

In a first step of this aspect, a critical point filter is applied to a source image to generate a series of source hierarchical images each having a different resolution. In a second step, a critical point filter is applied to a destination image to generate a series of destination hierarchical images. Source and destination hierarchical images stand for a group of images which are obtained by hierarchizing source and destination images, respectively, and each consist of two or more images. In a third step, matching between source and destination hierarchical images is computed. In this aspect, image characteristics concerning a critical point are extracted and/or clarified using a multiresolutional filter. This facilitates matching. According to this aspect, matching may be totally unconstrained.

Still another aspect of the base technology relates to matching source and destination images. In this aspect, an evaluation equation is set beforehand for each of a plurality of matching evaluation items; these equations are combined into a combined evaluation equation; and an optimal matching is detected while paying attention to the neighborhood of an extreme of the combined evaluation equation. A combined evaluation equation may be defined as a linear combination or a sum of these evaluation equations, at least one of which has been multiplied by a coefficient parameter. In such a case, the parameter may be determined by detecting the neighborhood of an extreme of the combined evaluation equation or any of the evaluation equation. The above description used the term “the neighborhood of an extreme,” because some error is tolerable as it does not seriously affect the base technology.

Since an extreme itself depends on the parameter, it becomes possible to determine an optical parameter based on the behavior of an extreme. Automatic determination of a parameter, which originally accompanies difficulties in tuning, is achieved.

### Embodiments of the Base Technology

Elemental techniques of the base technology will be first described in [1]. A concrete description of a processing procedure will then be given in [2], and experimental results will be reported in [3].

[1] Detailed Description of Elemental Techniques

[1.1] Introduction

Using a set of new multiresolutional filters called critical point filters, image matching is accurately computed. There is no need for any prior knowledge concerning objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, there is no need to manually specify the correspondence of points between the images.

The base technology can be applied to, for instance, completely automated morphing, object recognition, stereo photogrammetry, volume rendering, smooth generation of motion images from a small number of frames. When applied to the morphing, given images can be automatically transformed. When applied to the volume rendering, intermediate images between cross sections can be accurately reconstructed, even when the distance between them is rather long and the cross sections vary widely in shape.

[1.2] The Hierarchy of the Critical Point Filters

The multiresolutional filters according to the base technology can preserve the intensity and locations of each critical point included in the images while reducing the resolution. Now, let the width of the image be N and the height of the image be M. For simplicity, assume that N=M=2n where n is a positive integer. An interval (0, N) ⊂ R is denoted by I. A pixel of the image at position (i, j) is denoted by p^{(i,j)} where i,j εI.

Here, a multiresolutional hierarchy is introduced. Hierarchized image groups are produced by a multiresolutional filter. The multiresolutional filter carries out a two dimensional search on an original image and detects critical points therefrom. The multiresolutinal filter then extracts the critical points from the original image to construct another image having a lower resolution. Here, the size of each of the respective images of the m-th level is denoted as 2^{m}×2^{m} (0≦m≦n). A critical point filter constructs the following four new hierarchical images recursively, in the direction descending from n.
p_{(i,j)}^{(m,0)}=min(min(p_{(2l,2j)}^{(m+1,0)},p_{(2i,2j+1)}^{(m+1,0)},min(p_{(2i+1,2j)}^{(m+1,0)},p_{(2i+1,2j+1)}^{(m+1,0)}))
p_{(i,j)}^{(m,1)}=max(min(p_{(2l,2j)}^{(m+1,1)},p_{(2i,2j+1)}^{(m+1,1)},min(p_{(2i+1,2j)}^{(m+1,1)},p_{(2i+1,2j+1)}^{(m+1,1)}))
p_{(i,j)}^{(m,2)}=min(max(p_{(2i,2j)}^{(m+1,2)},p_{(2i,2j+1)}^{(m+1,2)},max(p_{(2i+1,2j)}^{(m+1,2)},p_{(2i+1,2j+1)}^{(m+1,2)}))
p_{(i,j)}^{(m,3)}=max(max(p_{(2i,2j)}^{(m+1,3)},p_{(2i,2j+1)}^{(m+1,3)},max(p_{(2i+1,2j)}^{(m+1,3)},p_{(2l+1,2j+1)}^{(m+1,3)}))

where let
p_{(i,j)}^{(m,0)}=p_{(i,j)}^{(n,1)}=p_{(i,j}^{(n,2)}=p_{(i,j)}^{(n,3)}=p_{(i,j)} (2)

The above four images are referred to as subimages hereinafter. When min_{x≦t≦x+1} and max_{x≦t≦x+1} are abbreviated to α and β, respectively, the subimages can be expressed as follows.
p^{(m,0)=α(}x)α(y)p^{(m+1,0)}
p^{(m,1)=α(}x)β(y)p^{(m+1,1)}
p^{(m,2)=β(}x)α(y)p^{(m+1,2)}

Namely, they can be considered analogous to the tensor products of α and β. The subimages correspond to the respective critical points. As is apparent from the above equations, the critical point filter detects a critical point of the original image for every block consisting of 2×2 pixels. In this detection, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are detected as a local maximum point, a local minimum point, and a saddle point, respectively.

By using the critical point filter, an image (I pixel here) of a critical point detected inside each of the respective blocks serves to represent its block image (4 pixels here). Thus, resolution of the image is reduced. From a singularity theoretical point of view, α(x)α(y) preserves the local minimum point (minima point), β(x)β(y) preserves the local maximum point (maxima point), α(x)β(y) and β(x)α(y) preserve the saddle point.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of the resolution levels. First, the minima points are matched using p^{(m,0)}. Next, the saddle points are matched using p^{(m,1)} based on the previous matching result for the minima points. Other saddle points are matched using p^{(m,2)}. Finally, the maxima points are matched using p^{(m,3)}.

FIGS. 1(c) and 1(d) show the subimages p^{(5,0)} of the images in FIGS. 1(a) and 1(b), respectively. Similarly, FIGS. 1(e) and 1(f) show the subimages p^{(5,1)}. FIGS. 1(g) and 1(h) show the subimages p^{(5,2)}. FIGS. 1(i) and 1(j) show the subimages p^{(5,3)}. Characteristic parts in the images can be easily matched using subimages. The eyes can be matched by p^{(5,0)} since the eyes are the minima points of pixel intensity in a face. The mouths can be matched by p^{(5,1)} since the mouths have low intensity in the horizontal direction. Vertical lines on the both sides of the necks become clear by p^{(5,2)}. The ears and bright parts of cheeks become clear by p^{(5,3)} since these are the maxima points of pixel intensity.

As described above, the characteristics of an image can be extracted by the critical point filter. Thus, by comparing, for example, the characteristics of an image shot by a camera and with the characteristics of several objects recorded in advance, an object shot by the camera can be identified.

[1.3] Computation of Mapping Between Images

The pixel of the source image at the location (i,j) is denoted by p_{(i,j)}⁽ⁿ⁾ and that of the destination image at (k,l) is denoted by q_{(k,l)}⁽ⁿ⁾ where i, j, k, l εI. The energy of the mapping between the images (described later) is then defined. This energy is determined by the difference in the intensity of the pixel of the source image and its corresponding pixel of the destination image and the smoothness of the mapping. First, the mapping f^{(m,0)}:p^{(m,0)}→q^{(m,0)} between p^{(m,0)} and q^{(m,0)} with the minimum energy is computed. Based on f^{(m,0)}, the mapping f^{(m,1)} between p^{(m,1)} and q^{(m,1)} with the minimum energy is computed. This process continues until f^{(m,3)} between p^{(m,3)} and q^{(m,3)} is computed. Each f^{(m,i)} (i=0, 1, 2, . . . ) is referred to as a submapping. The order of i will be rearranged as shown in the following (3) in computing f^{(m,1)} for the reasons to be described later.
f^{(m,l)}:p^{(m,σ(l))}→q^{(m,σ(i))} (3)

where σ (i) ε{0, 1, 2, 3}.

[1.3.1] Bijectivity

When the matching between a source image and a destination image is expressed by means of a mapping, that mapping shall satisfy the Bijectivity Conditions (BC) between the two images (note that a one-to-one surjective mapping is called a bisection). This is because the respective images should be connected satisfying both surjection and injection, and there is no conceptual supremacy existing between these images. It is to be noted that the mappings to be constructed here are the digital version of the bijection. In the base technology, a pixel is specified by a grid point.

The mapping of the source subimage (a subimage of a source image) to the destination subimage (a subimage of a destination image) is represented by f^{(m, s)}: I/2^{n-m}×I/2^{n-m}→I/2^{n-m}×I/2^{n-m} (s=0, 1, . . . ), where f_{(i,j)}^{(m,s)}=(k,l) means that p_{(k,j)}^{(m,s)} of the source image is mapped to q_{(k,l)}^{(m,s)} of the destination image. For simplicity, when f(i,j)=(k,l) holds, a pixel q_{(k,l)} is denoted by q_{f(i,j)}.

When the data sets are discrete as image pixels (grid points) treated in the base technology, the definition of bijectivity is important. Here, the bisection will be defined in the following manner, where i,i′,j,j′,k and l are all integers. First, each square region (4)
p_{(i,j)}^{(m,s)}p_{(i+1,j)}^{(m,s)}p_{(i+1,j+1)}^{(m,s)}p_{(i,j+1)}^{(m,s)} (4)

on the source image plane denoted by R is considered, where i=0, . . . , 2^{m}−1, and j=0, . . . , 2^{m}−1. The edges of R are directed as follows.
p̅_̅{̅(̅i̅,̅j̅)̅}̅^̅{̅(̅m̅,̅s̅)̅}̅p̅_̅{̅(̅i̅+̅1̅,̅j̅)̅}̅^̅{̅(̅m̅,̅s̅)̅}̅, p̅_̅{̅(̅i̅+̅1̅,̅j̅)̅}̅^̅{̅(̅m̅,̅s̅)̅}̅p̅_̅{̅(̅i̅+̅1̅,̅j̅+̅1̅)̅}̅^̅{̅(̅m̅,̅s̅)̅}̅, p̅_̅{̅(̅i̅+̅1̅,̅j̅+̅1̅)̅}̅^̅{̅(̅m̅,̅s̅)̅}̅p̅_̅{̅(̅i̅,̅j̅+̅1̅)̅}̅^̅{̅(̅m̅,̅s̅)̅}̅ and p̅_̅{̅(̅i̅,̅j̅+̅1̅)̅}̅^̅{̅(̅m̅,̅s̅)̅}̅p̅_̅{̅(̅i̅,̅j̅)̅}̅^̅{̅(̅m̅,̅s̅)̅}̅ (5)

This square will be mapped by f to a quadrilateral on the destination image plane. The quadrilateral (6)
q_{(i,j)}^{(m,s)}q_{(i+1,j)}^{(m,s)}q_{(i+1,j+1)}^{(m,s)}q_{(i,j+1)}^{(m,s)} (6)

denoted by f^{(m, s)} (R) should satisfy the following bijectivity conditions (IBC).
(So, f^{(m,s)}(R)=f^{(m,s)}(p_{(i,j)}^{(m,s)}p_{(i+1,j)}^{(m,s)}p_{(i+1,j+1)}^{(m,s)}p_{(i,j+1)}^{(m,s)})=q_{(i,j)}^{(m,s)}q_{(i+1,j)}^{(m,s)}q_{(i+1,j+1)}^{(m,s)}q_{(i,j+1)}^{(m,s)})

1. The edges of the quadrilateral f^{(m, s)} (R) should not intersect one another.

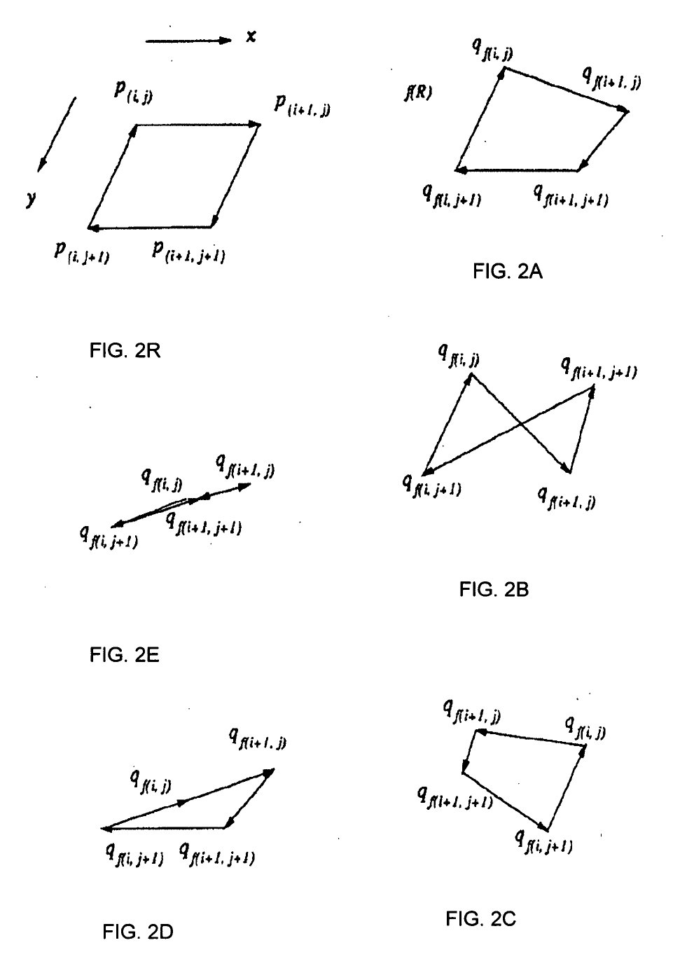

2. The orientation of the edges of f^{(m, s)} (R) should be the same as that of R (clockwise in the case of FIG. 2).

3. As a relaxed condition, retraction mapping is allowed.

The bijectivity conditions stated above shall be simply referred to as BC hereinafter. Without a certain type of a relaxed condition, there would be no mappings which completely satisfy the BC other than a trivial identity mapping. Here, the length of a single edge of f^{(m, s)} (R) may be zero. Namely, f^{(m, s)} (R) may be a triangle. However, it is not allowed to be a point or a line segment having area zero. Specifically speaking, if FIG. 2(R) is the original quadrilateral, FIGS. 2(A) and 2(D) satisfy BC while FIGS. 2(B), 2(C) and 2(E) do not satisfy BC.

In actual implementation, the following condition may be further imposed to easily guarantee that the mapping is surjective. Namely, each pixel on the boundary of the source image is mapped to the pixel that occupies the same locations at the destination image. In other words, f(i,j)=(i,j) (on the four lines of i=0, i=2^{m}−1, j=0, j=2^{m}−1). This condition will be hereinafter referred to as an additional condition.

[1.3.2] Energy of Mapping

[1.3.2.1] Cost Related to the Pixel Intensity

The energy of the mapping f is defined. An objective ere is to search a mapping whose energy becomes minimum. The energy is determined mainly by the difference in the intensity of between the pixel of the source image and its corresponding pixel of the destination image. Namely, the energy C_{(i,j)}^{(m,s)} of the mapping f^{(m, s)} at (i,j) is determined by the following equation (7).
C_{(i,f)}^{(m,s)}=|V(p_{(i,j)}^{(m,s)})−V(q_{f(i,j)}^{(m,s)})|² (7)

where V(p_{(i,f)}^{(m,s)}) and V(q_{f(i,j)}^{(m,s)}) are the intensity values of the pixels p_{(i,j)}^{(m,s)} and q_{(i,f)}^{(m,s)}, respectively. The total energy C^{(m, s)} of f is a matching evaluation equation, and can be defined as the sum of C_{(i,j)}^{(m,s)} as shown in the following equation (8).

$${C}_{f}^{( m , s )} = {\sum }_{i = 0}^{i = {2}^{m} - 1} {\sum }_{j = 0}^{j = {2}^{m} - 1} {C}_{( i , j )}^{( m , s )} \qquad ( 8 )$$

[1.3.2.2] Cost Related to the Locations of the Pixel for Smooth Mapping

In order to obtain smooth mappings, another energy D_{f} for the mapping is introduced. The energy D_{f} is determined by the locations of p_{(i,j)}^{(m,s)} and q_{f(i,j)}^{(m,s)} (i=0, 1, . . . , 2^{m}−1, j=0, 1, . . . , 2^{m}−1), regardless of the intensity of the pixels. The energy D_{(i,f)}^{(m,s)} of the mapping f^{(m, s)} at a point (i,j) is determined by the following equation (9).
D_{(i,j)}^{(m,s)}=ηE_{0(i,f)}^{(m,s)}+E_{1(i,j)}^{(m,s)} (9)

where the coefficient parameter η which is equal to or greater than 0 is a real number. And we have

$$\begin{matrix} {E}_{0 ( i , j )}^{( m , s )} = {‖ ( i , j ) - {f}^{( m , s )} ( i , j ) ‖}^{2} & ( 10 ) \\ {E}_{1 ( i , j )}^{( m , s )} = {\sum }_{{i}^{′} = i - 1}^{i} {\sum }_{{j}^{′} = j - 1}^{j} {‖ ( {f}^{( m , s )} ( i , j ) - ( i , j ) ) - ( {f}^{( m , s )} ( {i}^{′} , {j}^{′} ) - ( {i}^{′} , {j}^{′} ) ) ‖}^{2} / 4 & ( 11 )\end{matrix}$$

where ∥(x,y)∥=\sqrt{x²+y²}- - - (12) and f(i′,j′) is defined to be zero for i′<0 and j′<0. E₀ is determined by the distance between (i,j) and f(i,j). E₀ prevents a pixel from being mapped to a pixel too far away from it. However, E₀ will be replaced later by another energy function. E₁ ensures the smoothness of the mapping. E₁ represents a distance between the displacement of p(i,j) and the displacement of its neighboring points. Based on the above consideration, another evaluation equation for evaluating the matching, or the energy D_{f} is determined by the following equation (13).

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} \qquad ( 13 )$$

[1.3.2.3] Total Energy of the Mapping

The total energy of the mapping, that is, a combined evaluation equation which relates to the combination of a plurality of evaluations, is defined as λC_{(i,f)}^{(m,s)}+D_{f}^{(m,s)}, where λ≦0 is a real number. The goal is to detect a state in which the combined evaluation equation has an extreme value, namely, to find a mapping which gives the minimum energy expressed by the following (14).

$${min}_{f} \{ λ {C}_{f}^{( m , s )} + {D}_{f}^{( m , s )} \} \qquad ( 14 )$$

Care must be exercised in that the mapping becomes an identity mapping if λ=0 and η=0 (i.e., f^{(m, s)} (i,j)=(i,j) for all i=0, 1, . . . , 2^{m}−1 and j=0, 1, . . . , 2^{m}−1) As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η=0 will be C_{f}^{(m,s)} only. As a result thereof, pixels would be randomly corresponded to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, the difference in the pixel intensity and smoothness is considered in the optical flow technique. However, the optical flow technique cannot be used for image transformation since the optical flow technique takes into account only the local movement of an object. Global correspondence can be detected by utilizing the critical point filter according to the base technology.

[1.3.3] Determining the Mapping with Multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, while mappings at other level is being considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint conditions.

Now, when the following equation (15) holds,

$$( {i}^{′} , {j}^{′} ) = ( ⌊ \frac{i}{2} ⌋ , ⌊ \frac{j}{2} ⌋ ) \qquad ( 15 )$$

p_{(i′,j′)}^{(m-1,s)} and q_{(i′,j′)}^{(m-1,s)} are respectively called the parents of p_{(i,j)}^{(m,s)} and q_{(i,j)}^{(m,s)}, where └x┘ denotes the largest integer not exceeding x. Conversely, p_{(i,f)}^{(m,s)} and q_{(i,f)}^{(m,s)} are the child of p_{(i′,f′)}^{(m-1,s)} and the child of q_{(i′,j′)}^{(m-1,s)}, respectively. A function parent(i,j) is defined by the following (16).

$$parent ( i , j ) = ( ⌊ \frac{i}{2} ⌋ , ⌊ \frac{j}{2} ⌋ ) \qquad ( 16 )$$

A mapping between p_{(i,j)}^{(m,s)} and q_{(i,j)}^{(m,s)} is determined by computing the energy and finding the minimum thereof. The value of f^{(m, s)} (i, j)=(k, l) is determined as follows using f(m−1,s) (m=1, 2, . . . , n). First of all, imposed is a condition that q_{(k,l)}^{(m,s)} should lie inside a quadrilateral defined by the following (17) and (18). Then, the applicable mappings are narrowed down by selecting ones that are thought to be reasonable or natural among them satisfying the BC.
q_{g}_{_{(m,s)}}_{(i-1,j-1)}^{(m,s)}q_{g}_{_{(m,s)}}_{i-1,j+1)}^{(m,s)}q_{g}_{_{(m,s)}}_{(i+1,j+1)}^{(m,s)}q_{g}_{_{(m,s)}}_{(i+1,j-1)}^{(m,s)} (17)
where
g^{(m,s)}(i,j)=f^{(m-1,s)}(parent(i,j))+f^{(m-1,s)}(parent(i,j)+(l,l)) (18)

The quadrilateral defined above is hereinafter referred to as the inherited quadrilateral of p_{(i,f)}^{(m,s)}. The pixel minimizing the energy is sought and obtained inside the inherited quadrilateral.

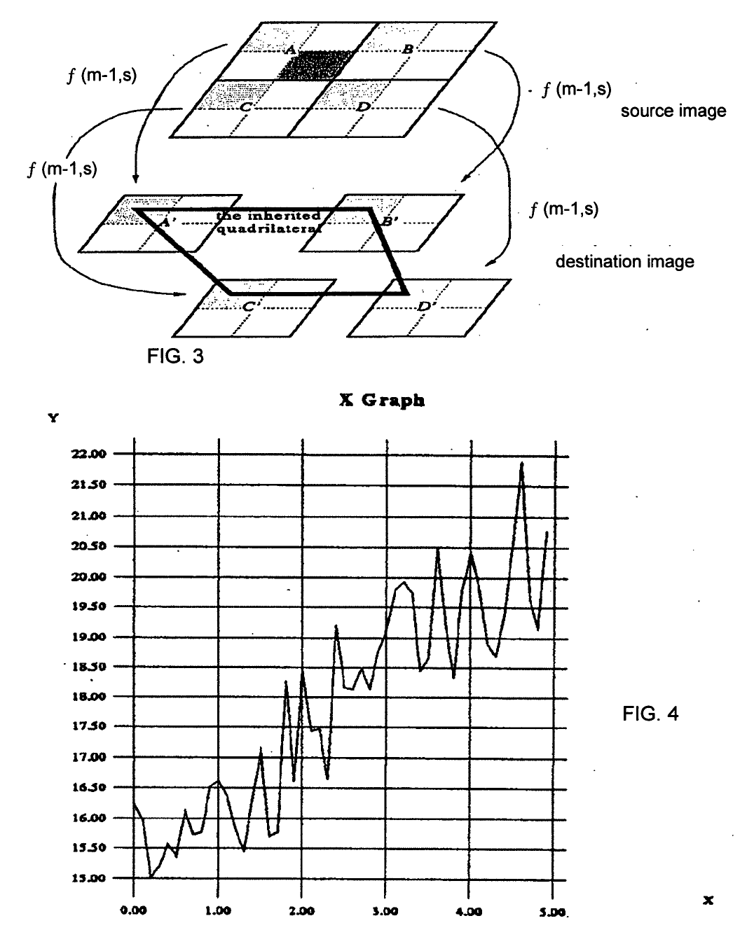

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{₍ₘ₎}_{(i,j)}^{(m,s)} which exists inside the inherited quadrilateral A′B′C′D′. Thereby, bridging from the mapping at the (m−1)th level to the mapping at the m-th level is achieved.

The energy E₀ defined above is now replaced by the following (19) and (20)
E_{0(i,j)}=∥f^{(m,0)}(i,j)−g^{(m)}(i,j)∥² (19)
E_{0(i,j)}=∥f^{(m,s)}(i,f)−f^{(m,s-1)}(i,j)∥²,(1≦i) (19)
for computing the submapping f^{(m,0)} and the submapping f^{(m,s)} at the m-th level, respectively.

In this manner, a mapping which keeps low the energy of all the submappings is obtained. Using the equation (20) makes the submappings corresponding to the different critical points associated to each other within the same level in order that the subimages can have high similarity. The equation (19) represents the distance between f^{(m,s)} (i,j) and the location where (i,j) should be mapped when regarded as a part of a pixel at the (m−1) the level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m,s)} (i,j). L is increased until such a pixel is found or L reaches its upper bound Lₘₐₓ^{(m)}. Lₘₐₓ^{(m)} is fixed for each level m. If no such a pixel is found at all, the third condition of the BC is ignored temporarily and such mappings that caused the area of the transformed quadrilateral to become zero (a point or a line) will be permitted so as to determine f^{(m,s)} (i,j). If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will be limited to the very small one, and only tiny changes in the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

[1.4] Automatic Determination of the Optimal Parameter Values

One of the main deficiencies of the existing image matching techniques lies in the difficulty of parameter adjustment. In most cases, the parameter adjustment is performed manually and it is extremely difficult to select the optical value. However, according to the base technology, the optimal parameter values can be obtained completely automatically.

The systems according to this base technology includes two parameters, namely, λ and η, where λ and η represent the weight of the difference of the pixel intensity and the stiffness of the mapping, respectively. The initial value for these parameters are 0. First, λ is gradually increased from λ=0 while η is fixed to 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena (1-4) are caused.

1. Pixels which should not be corresponded are erroneously corresponded only because their intensities are close.

2. As a result, correspondence between images becomes inaccurate, and the mapping becomes invalid.

3. As a result, D_{f}^{(m,s)} in the equation 14 tends to increase abruptly.

4. As a result, since the value of the equation 14 tends to increase abruptly, f^{(m,s)} changes in order to suppress the abrupt increase of D_{f}^{(m,s)}. As a result, C_{f}^{(m,s)} increases.

Therefore, a threshold value at which C_{f}^{(m,s)} turns to an increase from a decrease is detected while a state in which the equation (14) takes the minimum value with λ being increased is kept. Such λ is determined as the optimal value at η=0. Then, the behavior of C_{f}^{(m,s)} is examined while η is increased gradually, and η will be automatically determined by a method described later. λ will be determined corresponding to such the automatically determined η.

The above-described method resembles the focusing mechanism of human visual systems. In the human visual systems, the images of the respective right eye and left eye are matched while moving one eye. When the objects are clearly recognized, the moving eye is fixed.

[1.4.1] Dynamic Determination of λ

λ is increased from 0 at a certain interval, and the a subimage is evaluated each time the value of λ changes. As shown in the equation (14), the total energy is defined by λC_{f}^{(m,s)}+D_{f}^{(m,s)}. D_{(i,j)}^{(m,s)} in the equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, that changing the mapping reduces the total energy is impossible unless a changed amount (reduction amount) of the current λC_{(i,j)}^{(m,s)} is equal to or greater than 1. Since D_{f}^{(m,s)} increases by more than 1 accompanied by the change of the mapping, the total energy is not reduced unless is reduced by more than 1.

Under this condition, it is shown that C_{(i,j)}^{(m, s)} decreases in normal cases as λ increases. The histogram of C_{(i,j)}^{(m,s)} is denoted as h(l), where h(l) is the number of pixels whose energy C_{i,j)}^{(m,s)} is l². In order that λl²≦1, for example, the case of l²=1/λ is considered. When λ varies from λ₁ to λ₂, a number of pixels (denoted A) expressed by the following (21)

$$\begin{matrix}A = {\sum }_{i = ⌈ \frac{1}{{λ}_{2}} ⌉}^{⌈ \frac{1}{{λ}_{1}} ⌉} h ( l ) ≅ {\int }_{i = \frac{1}{{λ}_{2}}}^{\frac{1}{{λ}_{1}}} h ( l ) ⅆ l \\ = - {\int }_{{λ}_{2}}^{{λ}_{1}} h ( l ) \frac{1}{{λ}^{3 / 2}} ⅆ λ \\ = {\int }_{{λ}_{1}}^{{λ}_{2}} \frac{h ( l )}{{λ}^{3 / 2}} ⅆ λ\end{matrix} \qquad ( 21 )$$

changes to a more stable state having the energy (22) which is

$${C}_{f}^{( m , s )} - {l}^{2} = {C}_{f}^{( m , s )} - \frac{1}{λ} . \qquad ( 22 )$$

Here, it is assumed that all the energy of these pixels is approximated to be zero. It means that the value of C_{(i,j)}^{(m,s)} changes by (23).

$$\partial {C}_{f}^{( m , s )} = - \frac{A}{λ} \qquad ( 23 )$$

As a result, the equation (24) holds.

$$\frac{\partial {C}_{f}^{( m , s )}}{\partial λ} = - \frac{h ( l )}{{λ}^{5 / 2}} \qquad ( 24 )$$

Since h(l)>0, C_{f}^{(m,s)} decreases in normal case. However, when λ tends to exceed the optimal value, the above phenomenon that is characterized by the increase in C_{f}^{(m,s)} occurs. The optimal value of λ is determined by detecting this phenomenon.

When

$$h ( l ) = {Hl}^{k} = \frac{H}{{λ}^{k / 2}} \qquad ( 25 )$$

is assumed where both H(h>0) and k are constants, the equation (26) holds.

$$\frac{\partial {C}_{f}^{( m , s )}}{\partial λ} = - \frac{H}{{λ}^{5 / 2 + k / 2}} \qquad ( 26 )$$

Then, if k≠−3, the following (27) holds.

$${C}_{f}^{( m , s )} = C + \frac{H}{( 3 / 2 + k / 2 ) {λ}^{3 / 2 + k / 2}} \qquad ( 27 )$$

The equation (27) is a general equation of C_{f}^{(m,s)} (where C is a constant).

When detecting the optimal value of λ, the number of pixels violating the BC may be examined for safety. In the course of determining a mapping for each pixel, the probability of violating the BC is assumed p₀ here. In that case, since

$$\frac{\partial A}{\partial λ} = \frac{h ( l )}{{λ}^{3 / 2}} \qquad ( 28 )$$

holds, the number of pixels violating the BC increases at a rate of the equation (29).

$${B}_{0} = \frac{h ( l ) {p}_{0}}{{λ}^{3 / 2}} \qquad ( 29 )$$

Thus,

$$\frac{{B}_{0} {λ}^{3 / 2}}{{p}_{0} h ( l )} = 1 \qquad ( 30 )$$

is a constant. If assumed that h(l)=Hl^{k}, the following (31), for example,
B₀λ^{3/2+k/2}=p₀H (31)
becomes a constant. However, when λ exceeds the optimal value, the above value of (31) increases abruptly. By detecting this phenomenon, whether or not the value of B₀λ^{3/2+k/2}/2^{m} exceeds an abnormal value B_{0 thres} exceeds is inspected, so that the optimal value of can be determined. Similarly, whether or not the value of B₁λ^{3/2+k/2}/2^{m} exceeds an abnormal value B_{1 thres}, so that the increasing rate Bₗ of pixels violating the third condition of the BC is checked. The reason why the fact 2^{m} is introduced here will be described at a later stage. This system is not sensitive to the two threshold values B_{0 thres} and B_{1 thres}. The two threshold values B_{0 thres} and B_{1 thres} can be used to detect the excessive distortion of the mapping which is failed to be detected through the observation of the energy C_{f}^{(m,s)}.

In the experimentation, the computation of f^{(m, s)} is stopped and then the computation of f_{f}^{(m, s+1)} is started when λ exceeded 0.1. That is because the computation of submappings is affected by the difference of mere 3 out of 255 levels in the pixel intensity when λ>0.1, and it is difficult to obtain a correct result when λ>0.1.

[1.4.2] Histogram h(l)

The examination of C_{f}^{(m,s)} does not depend on the histogram h(l). The examination of the BC and its third condition may be affected by the h(l). k is usually close to 1 when (λ, C_{f}^{(m,s)}) is actually plotted. In the experiment, k=1 is used, that is, B₀λ² and B₁λ² are examined. If the true value of k is less than l, B₀λ² and B₁λ² does not become constants and increase gradually by the factor of λ^{(1-k)/2}. If h(l) is a constant, the factor is, for example, λ^{1/2}. However, such a difference can be absorbed by setting the threshold B_{0 thres} appropriately.

Let us model the source image by a circular object with its center at (x₀,y₀) and its radius r, given by:

$$p ( i , j ) = \{ \begin{matrix}\frac{255}{r} c ( \sqrt{{( i - {x}_{0} )}^{2} + {( j - {y}_{0} )}^{2}} ) … ( \sqrt{{( i - {x}_{0} )}^{2} + {( j - {y}_{0} )}^{2}} \leq r ) \\ 0 … ( otherwise )\end{matrix} \qquad ( 32 )$$

and the destination image given by:

$$q ( i , j ) = \{ \begin{matrix}\frac{255}{r} c ( \sqrt{{( i - {x}_{1} )}^{2} + {( j - {y}_{1} )}^{2}} ) … ( \sqrt{{( i - {x}_{1} )}^{2} + {( j - {y}_{1} )}^{2}} \leq r ) \\ 0 … ( otherwise )\end{matrix} \qquad ( 33 )$$

with its center at (x₁,y₁) and radius r. Let c(x) has the form of c(x)=x^{k}. When the centers (x₀,y₀) and (x₁,y₁) are sufficiently far from each other, the histogram h(l) is then in the form of:
h(l)∝rl^{k}(k≠0) (34)

When k=l, the images represent objects with clear boundaries embedded in the backgrounds. These objects become darker toward their centers and brighter toward their boundaries. When k=−l, the images represent objects with vague boundaries. These objects are brightest at their centers, and become darker toward boundaries. Without much loss of generality, it suffices to state that objects in general are between these two types of objects. Thus, k such that −1≦k≦1 can cover the most cases, and it is guaranteed that the equation (27) is generally a decreasing function.

As can be observed from the above equation (34), attention must be directed to the fact that r is Influenced by the resolution of the image, namely, r is proportional to 2^{m}. That is why the factor 2^{m} was introduced in the above section [1.4.1].

[1.4.3] Dynamic Determination of η

The parameter η can also be automatically determined in the same manner. Initially, η is set to zero, and the final mapping f⁽ⁿ⁾ and the energy C_{f}⁽ⁿ⁾ at the finest resolution are computed. Then, after η is increased by a certain value Δη and the final mapping f⁽ⁿ⁾ and the energy C_{f}⁽ⁿ⁾ at the finest resolution are again computed. This process is repeated until the optimal value is obtained. η represents the stiffness of the mapping because it is a weight of the following equation (35).
E₀_{_{(i,j)}}^{(m,s)}=∥f^{(m,s)}(i,j)−f^{(m,s-1)}(i,j)∥² (35)

When η is zero, D_{f}⁽ⁿ⁾ is determined irrespective of the previous submapping, and the present submapping would be elastically deformed and become too distorted. On the other hand, when η is a very large value, D_{f}⁽ⁿ⁾ is almost completely determined by the immediately previous submapping. The submappings are then very stiff, and the pixels are mapped to almost the same locations. The resulting mapping is therefore the identity mapping. When the value of n increases from 0, C_{f}⁽ⁿ⁾ gradually decreases as will be described later. However, when the value of η exceeds the optimal value, the energy starts increasing as shown in FIG. 4. In FIG. 4, the x-axis represents η, and y-axis represents Cᵣ.

The optimum value of η which minimizes C_{f}⁽ⁿ⁾ can be obtained in this manner. However, since various elements affects the computation compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of η. Thus, whether the obtained value of C_{f}⁽ⁿ⁾ is the minimum or not cannot be judged instantly. When candidates for the minimum value are found, the true minimum needs to be searched by setting up further finer interval.

[1.5] Supersampling

When deciding the correspondence between the pixels, the range of f^{(m, s)} can be expanded to R×R (R being the set of real numbers) in order to increase the degree of freedom. In this case, the intensity of the pixels of the destination image is interpolated, so that f^{(m, s)} having the intensity at non-integer points
V(q_{f}_{_{(m,s)}}_{(i,j)}^{(m,s)}) (36)
is provided. Namely, supersampling is performed. In its actual implementation, f^{(m, s)} is allowed to take integer and half integer values, and
V(q_{i,j)+(0.5,0.5)}^{(m,s)}) (37)
is given by
(V(q_{(i,j)}^{(m,s)})+V(q_{(i,j)+(1,1)}^{(m,s)}))/2 (38)

[1.6] Normalization of the Pixel Intensity of Each Image

When the source and destination images contain quite different objects, the raw pixel intensity may not be used to compute the mapping because a large difference in the pixel intensity causes excessively large energy C_{f}^{(m,s)} relating the intensity, thus making it difficult to perform the correct evaluation.

For example, the matching between a human face and a cat's face is computed. The cat's face is covered with hair and is a mixture of very bright pixels and very dark pixels. In this case, in order to compute the submappings of the two faces, its subimages are normalized. Namely, the darkest pixel intensity is set to 0 while the brightest pixel intensity is set to 255, and other pixel intensity values are obtained using the linear interpolation.

[1.7] Implementation

In the implementation, utilized is a heuristic method where the computation proceeds linearly as the source image is scanned. First, the value of f^{(m, s)} is determined at the top leftmost pixel (i,j)=(0,0). The value of each f^{(m, s)} (i,j) is then determined while i is increased by one at each step. When i reaches the width of the image, j is increased by one and i is reset to zero. Thereafter, f^{(m, s)} (i, j) is determined while scanning the source image. Once pixel correspondence is determined for all the points, it means that a single mapping f^{(m, s)} is determined.

When a corresponding point q_{f(i,j)} is determined for p_{(i,j)}, a corresponding point q_{f(i,j+1)} of p_{(i,j+1)} is determined next. The position of q_{f(i,j+1)} is constrained by the position of q_{f(i,j)} since the position of q_{f(i,j+1)} satisfies the BC. Thus, in this system, a point whose corresponding point is determined earlier is given higher priority. If the situation continues in which (0,0) is always given the highest priority, the final mapping might be unnecessarily biased. In order to avoid this bias, f^{(m, s)} is determined in the following manner in the base technology.

First, when (s mod 4) is 0, f^{(m, s)} is determined starting from (0,0) while gradually increasing both i and j. When (s mod 4) is 1, it is determined starting from the top rightmost location while decreasing i and increasing j. When (s mod 4) is 2, it is determined starting from the bottom rightmost location while decreasing both i and j. When (s mod 4) is 3, it is determined starting from the bottom leftmost location while increasing i and decreasing j. Since a concept such as the submapping, that is, a parameter s, does not exist in the finest n-th level, f^{(m, s)} is computed continuously in two directions on the assumption that s=0 and s=2.

In the actual implementation, the values of f^{(m, s)} (i, j) (m=0, . . . , n) that satisfy the BC are chosen as much as possible, from the candidates (k,l) by awarding a penalty to the candidates violating the BC. The energy D_{(k,l)} of the candidate that violates the third condition of the BC is multiplied by φ and that of a candidate that violates the first or second condition of the BC is multiplied by φ. in the actual implementation, φ=2 and φ=100000 are used.

In order to check the above-mentioned BC, the following test is performed as the actual procedure when determining (k,1)=f^{(m, s)} (i,j). Namely, for each grid point (k,l) in the inherited quadrilateral of f^{(m,s)} (i, j), whether or not the z-component of the outer product of

$$W = {A}^{ρ} \times {B}^{ρ} \qquad ( 39 )$$

is equal to or greater than 0 is examined, where

$${A}^{ρ} = \overline{{q}_{{f}^{( m , s )} ( i , j - 1 )}^{( m , s )} {q}_{{f}^{( m , s )} ( l + 1 , j - 1 )}^{( m , s )}} \qquad ( 40 )$$

$${B}^{ρ} = \overline{{q}_{{f}^{( m , s )} ( i , j - 1 )}^{( m , s )} {q}_{( k , l )}^{( m , s )}} \qquad ( 41 )$$

Here, the vectors are regarded as 3D vectors and the z-axis is defined in the orthogonal right-hand coordinate system. When W is negative, the candidate is awarded a penalty by multiplying D_{(k,l)}^{(m,s)} by φ so as not to be selected as much as possible.

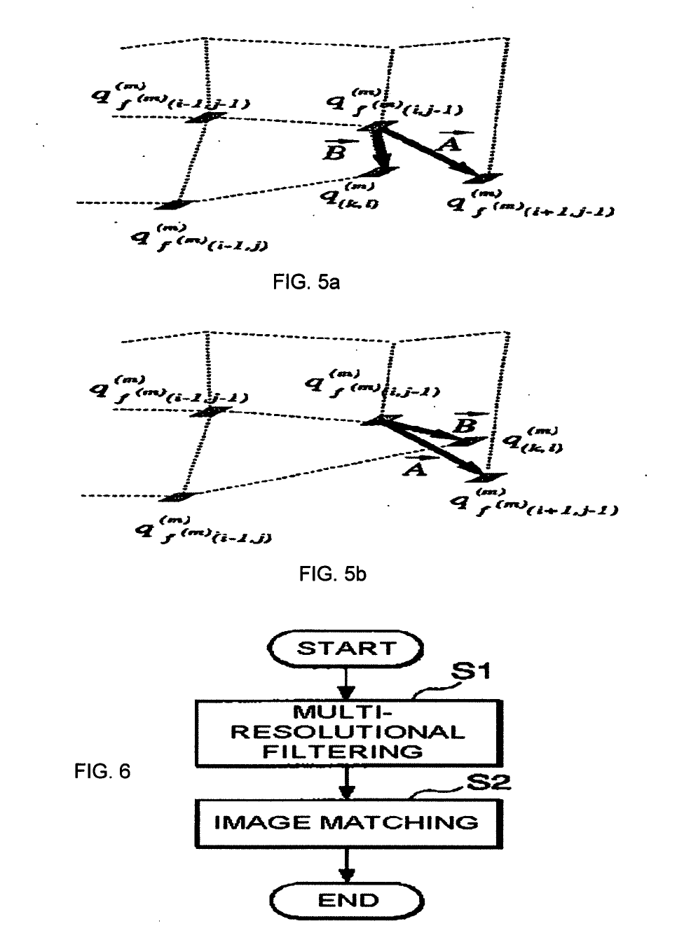

FIGS. 5(a) and 5(b) illustrate the reason why this condition is inspected. FIG. 5(a) shows a candidate without a penalty and FIG. 5(b) shows one with a penalty. When determining the mapping f^{(m, s)} (i,j+1) for the adjacent pixel at (i,j+1), there is no pixel on the source image plane that satisfies the BC if the z-component of W is negative because then q_{(k,1)}^{(m,s)} passes the boundary of the adjacent quadrilateral.

[1.7.1] The Order of Submappings

In the actual implementation, σ(0)=0, σ(1)=1, σ(2)=2, σ(3)=3, σ(4)=0 were used when the resolution level was even, while σ(0)=3, σ(1)=2, σ(2)=1, σ(3)=0, σ(4)=3 were used when the resolution level was odd. Thus, the submappings are shuffled in an approximately manner. It is to be noted that the submapping is primarily of four types, and s may be any one among 0 to 3. However, a processing with s=4 was actually performed for the reason described later.

[1.8] Interpolations

After the mapping between the source and destination images is determined, the intensity values of the corresponding pixels are interpolated. In the implementation, trilinear interpolation is used. Suppose that a square p_{(i,j)}p_{(i+l,j)}p_{(i+l,j+1)}p_{(i,j+1)} on the source image plane is mapped to a quadrilateral q_{f(i,j)}q_{f(i+l,j)}q_{f(i+1,j+1)}q_{f(i,j+1)} on the destination image plane. For simplicity, the distance between the image planes is assumed 1. The intermediate image pixels r(x,y,t) (0≦x≦N−1, 0≦y≦M−1) whose distance from the source image plane is t (0≦t≦1) are obtained as follows. First, the location of the pixel r(x,y,t), where x,y,tεR, is determined by the equation (42).

$$\begin{matrix}( x , y ) = ( 1 - dx ) ( 1 - dy ) ( 1 - t ) ( i , j ) + ( 1 - dx ) ( 1 - dy ) tf ( i , j ) + \\ dx ( 1 - dy ) ( 1 - t ) ( i + 1 , j ) + dx ( 1 - dy ) tf ( 1 + 1 , j ) + \\ ( 1 - dx ) dy ( 1 - t ) ( i , j + 1 ) + ( 1 - dx ) dytf ( i , j + 1 ) + \\ dxdy ( 1 - t ) ( 1 + 1 , j + 1 ) + dxdyt ( i + 1 , j + 1 )\end{matrix} \qquad ( 42 )$$

The value of the pixel intensity at r(x,y,t) is then determined by the equation (43).

$$\begin{matrix}V ( r ( x , y , t ) ) = ( 1 - dx ) ( 1 - dy ) ( 1 - t ) V ( {p}_{( i , j )} ) + ( 1 - dx ) ( 1 - dy ) tV ( {q}_{f ( i , j )} ) + \\ dx ( 1 - dy ) ( 1 - t ) V ( {p}_{( i + 1 , j )} ) + dx ( 1 - dy ) tV ( {q}_{f ( i + 1 , j )} ) + \\ ( 1 - dx ) dy ( 1 - t ) V ( {p}_{( i , j + 1 )} ) + ( 1 - dx ) dytV ( {q}_{f ( i , j + 1 )} ) + \\ dxdy ( 1 - t ) V ( {p}_{( i + 1 , j + 1 )} ) + dxdytV ( {q}_{f ( i + 1 , j + 1 )} )\end{matrix} \qquad ( 43 )$$

where dx and dy are parameters varying from 0 to 1.

[1.9] Mapping on which Constraints are Imposed

So far, the determination of the mapping to which no constraint is imposed has been described. However, when a correspondence between particular pixels of the source and destination images is provided in a predetermined manner, the mapping can be determined using such correspondence as a constraint.

The basic idea is that the source image is roughly deformed by an approximate mapping which maps the specified pixels of the source image to the specified pixels of the destination images and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of the specified pixels are mapped to the locations near the position to which the specified one is mapped. Here, the approximate mapping at the m-th level in the resolution hierarchy is denoted by F^{(m)}.

The approximate mapping F is determined in the following manner. First, the mapping for several pixels are specified. When nₛ pixels
p(i₀,j₀),p(i₁,j₁), . . . , p(i_{n,-1},jₙ_{ₛ}₋₁) (44)
of the source image are specified, the following values in the equation (45) are determined.
F⁽ⁿ⁾(i₀,j₀)=(k₀,l₀)
F⁽ⁿ⁾(i₁,j₁)=(k₁,l₁), . . . , (45)
F⁽ⁿ⁾(iₙ_{ₛ}₋₁,jₙ_{ₛ}₋₁)=(kₙ_{ₛ}₋₁,lₙ_{ₛ}₋₁) (45)

For the remaining pixels of the source image, the amount of displacement is the weighted average of the displacement of p(iₕ, jₕ) (h=0, . . . , nₛ−1). Namely, a pixel p_{(i,j)} is mapped to the following pixel (expressed by the equation (46)) of the destination image.

$$\begin{matrix}{F}^{( m )} ( i , j ) = \frac{( i , j ) + {\sum }_{h = 1}^{h = n , - 1} ( {k}_{h} - {i}_{h} , {I}_{h} - {j}_{h} ) {weight}_{h} ( i , j )}{{2}^{n - m}} & ( 46 ) \\ where & \\ {weight}_{h} ( i , j ) = \frac{1 / {‖ ( {i}_{h} - i , {j}_{h} - j ) ‖}^{2}}{total\_weight ( i , j )} & ( 47 ) \\ where & \\ total\_weight ( i , j ) = {\sum }_{h = 0}^{h = n , - 1} 1 / {‖ ( {i}_{h} - i , {j}_{h} - j ) ‖}^{2} & ( 48 )\end{matrix}$$

Second, the energy D_{(i,j)}^{(m,s)} of the candidate mapping f is changed so that mapping f similar to F^{(m)} has a lower energy. Precisely speaking, D_{(i,j)}^{(m,s)} is expressed by the equation (49).

$$\begin{matrix}{D}_{( i , j )}^{( m , s )} = {E}_{{0}_{( i , j )}}^{( m , s )} + η {E}_{{1}_{( i , j )}}^{( m , s )} + κ {E}_{{2}_{( i , j )}}^{( m , s )} & ( 49 ) \\ {E}_{{2}_{( i , j )}}^{( m , s )} = \{ \begin{matrix}0 , & if {‖ {F}^{( m )} ( i , j ) - {f}^{( m , s )} ( i , j ) ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , & otherwise\end{matrix} & ( 50 )\end{matrix}$$

where κ, ρ≧0. Finally, the mapping f is completely determined by the above-described automatic computing process of mappings.

Note that E₂_{_{(i,j)}}^{(m,s)} becomes 0 if f^{(m,s)} (i,j) is sufficiently close to F^{(m)}(i,j) i.e., the distance therebetween is equal to or less than

$$⌊ \frac{{ρ}^{2}}{{2}^{2 ( n - m )}} ⌋ \qquad ( 51 )$$

It is defined so because it is desirable to determine each value f^{(m, s)} (i,j) automatically to fit in an appropriate place in the destination image as long as each value f^{(m, s)} (i,j) is close to F^{(m)} (i,j). For this reason, there is no need to specify the precise correspondence in detail, and the source image is automatically mapped so that the source image matches the destination image.

[2] Concrete Processing Procedure

The flow of the process utilizing the respective elemental techniques described in [1] will be described.

FIG. 6 is a flowchart of the entire procedure of the base technology. Referring to FIG. 6, a processing using a multiresolutional critical point filter is first performed (S1). A source image and a destination image are then matched (S2). S2 is not indispensable, and other processings such as image recognition may be performed instead, based on the characteristics of the image obtained at S1.

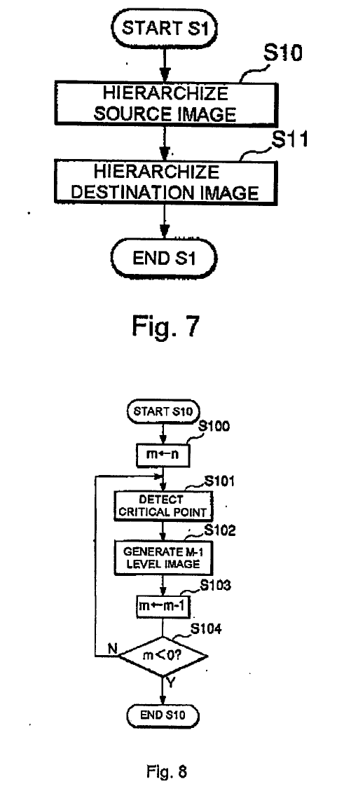

FIG. 7 is a flowchart showing the details of the process at S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel.

FIG. 8 is a flowchart showing the details of the process at S10 shown in FIG. 7. Suppose that the size of the original source image is 2ⁿ×2ⁿ. Since source hierarchical images are sequentially generated from one with a finer resolution to one with a coarser resolution, the parameter m which indicates the level of resolution to be processed is set to n (S100). Then, critical points are detected from the images p^{(m,0)}, p^{(m,1)}, p^{(m,2)} and p^{(m,3)} of the m-th level of resolution, using a critical point filter (S101), so that the images p^{(m-1,0)}, p^{(m-1,1)}, p^{(m-1,2)} and p^{(m-1,3)} of the (m−1)th level are generated (S102). Since m=n here, p^{(m,0)}=p^{(m,1)}=p^{(m,2)}=p^{(m,3)}=p⁽ⁿ⁾ holds and four types of subimages are thus generated from a single source image.

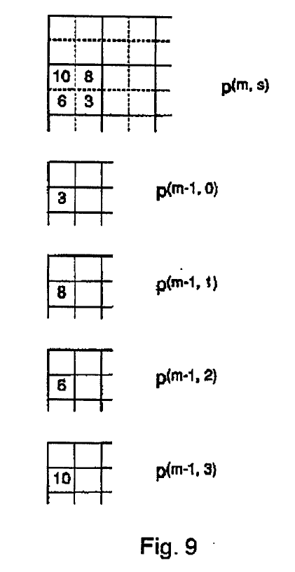

FIG. 9 shows correspondence between partial images of the m-th and those of (m−1)th levels of resolution. Referring to FIG. 9, respective values represent the intensity of respective pixels. p^{(m, s)} symbolizes four images p(m,0) through p^{(m,3)}, and when generating p^{(m-1,0)}, p^{(m, s)} is regarded as p^{(m,0)}. For example, as for the block shown in FIG. 9, comprising four pixels with their pixel intensity values indicated inside, images p^{(m-1,0)}, p^{(m-1,1)}, p^{(m-1,2)} and p^{(m-1,3)} acquire “3”, “8”, “6” and “10”, respectively, according to the rules described in [1.2]. This block at the m-th level is replaced at the (m−1)th level by respective single pixels acquired thus. Therefore, the size of the subimages at the (m−1)th level is 2^{m-1}×2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0 (0-th level) are generated to complete the process at S10. The size of the subimages at the 0-th level is 1×1.

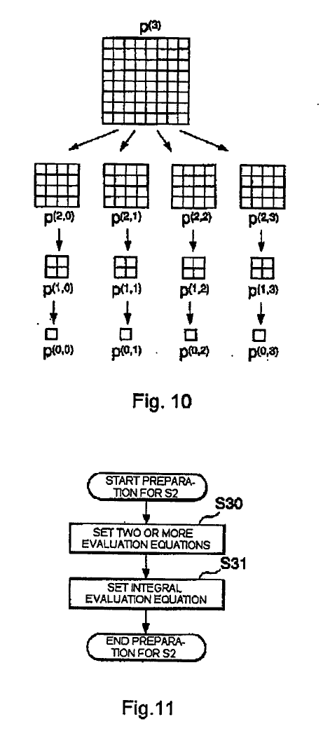

FIG. 10 shows source hierarchical images generated at S10 in the case of n=3. The initial source image is the only image common to the four series followed. The four types of subimages are generated independently, depending on the type of a critical point. Note that the process in FIG. 8 is common to S11 shown in FIG. 7, and that destination hierarchical images are generated through the similar procedure. Then, the process by S1 shown in FIG. 6 is completed.

In the base technology in order to proceed to S2 shown in FIG. 6 a matching evaluation is prepared. FIG. 11 shows the preparation procedure. Referring to FIG. 11, a plurality of evaluation equations are set (S30). Such the evaluation equations include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such the combined evaluation equation includes λC_{(i,j)}^{(m,s)}+D_{f}^{(m,s)}. Using η introduced in [1.3.2.2], we have
ΣΣ(λC_{(i,j)}^{(m,s)}+ηE_{0(i,j)}^{(m,s)}+E_{1(i,j)}^{(m,s)} (52)
In the equation (52) the sum is taken for each i and j where i and j run through 0, 1, . . . , 2^{m-1}. Now, the preparation for matching evaluation is completed.

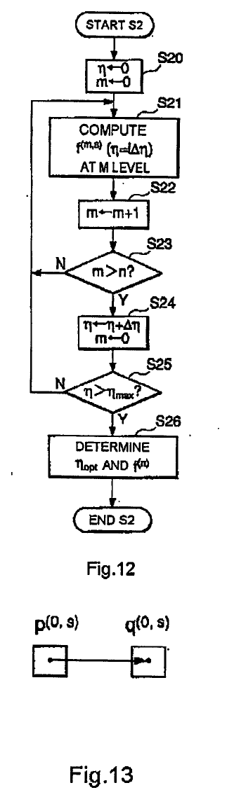

FIG. 12 is a flowchart showing the details of the process of S2 shown in FIG. 6. As described in [1], the source hierarchical images and destination hierarchical images are matched between images having the same level of resolution. In order to detect global corresponding correctly, a matching is calculated in sequence from a coarse level to a fine level of resolution. Since the source and destination hierarchical images are generated by use of the critical point filter, the location and intensity of critical points are clearly stored even at a coarse level. Thus, the result of the global matching is far superior to the conventional method.

Referring to FIG. 12, a coefficient parameter η and a level parameter m are set to 0 (S20). Then, a matching is computed between respective four subimages at the m-th level of the source hierarchical images and those of the destination hierarchical images at the m-th level, so that four types of submappings f^{(m, s)} (s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching. This is a vertical reference between different levels. If m=0, there is no coarser level and the process, but this exceptional process will be described using FIG. 13.

On the other hand, a horizontal reference within the same level is also performed. As indicated by the equation (20) in [1.3.3], f^{(m,3)}, f^{(m,2)} and f^{(m,1)} are respectively determined so as to be analogous to f^{(m,2)}, f^{(m,1)} and f^{(m,0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m,0)}, which is to be initially determined, a coarser level by one is referred to since there is no other submapping at the same level to be referred to as shown in the equation (19). In the experiment, however, a procedure is adopted such that after the submappings were obtained up to f^{(m,3)}, f^{(m,0)} is renewed once utilizing the thus obtained submappings as a constraint. This procedure is equivalent to a process in which s=4 is substituted into the equation (20) and f^{(m,4)} is set to f^{(m,0)} anew. The above process is employed to avoid the tendency in which the degree of association between f^{(m,0)} and f^{(m,3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

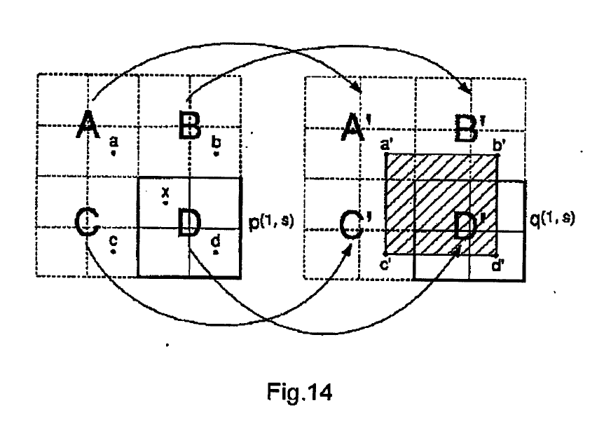

FIG. 13 illustrates how the submapping is determined at the 0-th level. Since at the 0-th level each sub-image is constituted by a single pixel, the four submappings f^{(0,s)} is automatically chosen as the identity mapping. FIG. 14 shows how the submappings are determined at the first level. At the first level, each of the sub-images is constituted of four pixels, which are indicated by a solid line. When a corresponding point (pixel) of the point (pixel) x in p^{(1,s)} is searched within q^{(1,s)}, the following procedure is adopted.

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the points A to C are virtual pixels which do not exist in reality.

3. The corresponding points A′ to D′ of the pixels A to D, which have already been defined at the 0-th level, are plotted in q^{(1,s)}. The pixels A′ to C′ are virtual pixels and regarded to be located at the same positions as the pixels A to C.

4. The corresponding point a′ to the point a in the pixel A is regarded as being located inside the pixel A′, and the point a′ is plotted. Then, it is assumed that the position occupied by the point a in the pixel A (in this case, positioned at the upper right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum in the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels (higher than the second level), the pixels A′ to D′ will be positioned apart from one another as shown in FIG. 3.

Once the four submappings at the m-th level are determined in this manner, m is incremented (S22 in FIG. 12). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾(η=0) because it has been determined relative to η=0.

Next, to obtain the mapping with respect to other different η, η is shifted by Δη and m is reset to zero (S24). After confirming that new η does not exceed a predetermined search-stop value ηₘₐₓ(S25), the process returns to S21 and the mapping f⁽ⁿ⁾ (η=Δη) relative to the new η is obtained. This process is repeated while obtaining f⁽ⁿ⁾(η=iΔη)(i=0, 1, . . . ) at S21. When η exceeds ηₘₐₓ, the process proceeds to S26 and the optimal η=ηₒₚₜ is determined using a method described later, so as to let f⁽ⁿ⁾(η=ηₒₚₜ) be the final mapping f⁽ⁿ⁾.

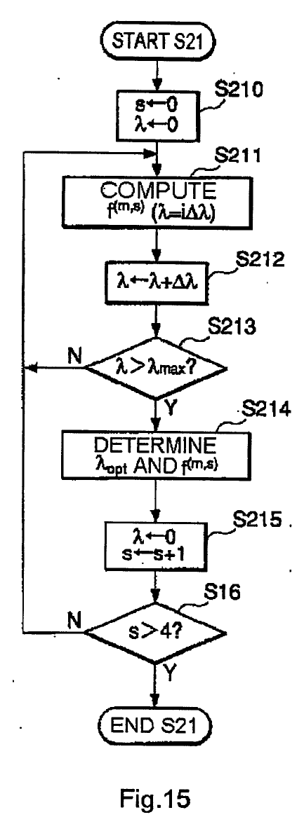

FIG. 15 is a flowchart showing the details of the process of S21 shown in FIG. 12. According to this flowchart, the submappings at the m-th level are determined for a certain predetermined η. When determining the mappings, the optimal λ is defined independently for each submapping in the base technology.

Referring to FIG. 15, s and λ are first reset to zero (S210). Then, obtained is the submapping f^{(m, s)} that minimizes the energy with respect to the then λ (and, implicitly, η) (S211), and the thus obtained is denoted as f^{(m, s)} (λ=0). In order to obtain the mapping with respect to other different λ, λ is shifted by Δλ. After confirming that new λ does not exceed a predetermined search-stop value λₘₐₓ (S213), the process returns to S211 and the mapping f^{(m, s)} (λ=Δλ) relative to the new λ is obtained. This process is repeated while obtaining f^{(m, s)} (λ=iΔλ)(i=0, 1, . . . ), When λ exceeds λₘₐₓ, the process proceeds to S214 and the optimal λ=λₒₚₜ is determined, so as to let f⁽ⁿ⁾(λ=λₒₚₜ) be the final mapping f^{(m, s)} (S214).

Next, in order to obtain other submappings at the same level, λ is reset to zero and s is incremented (S215). After confirming that s does not exceed 4 (S216), return to S211. When s=4, f^{(m,0)} is renewed utilizing f^{(m,3)} as described above and a submapping at that level is determined.

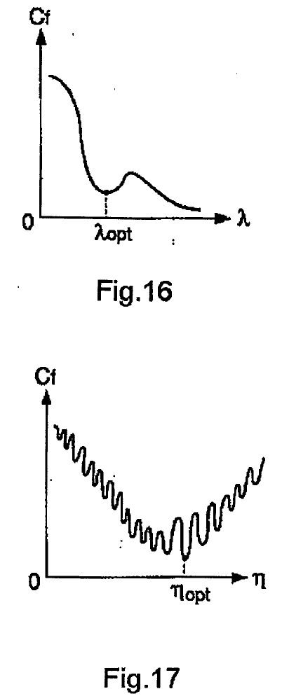

FIG. 16 shows the behavior of the energy C_{f}^{(m,s)} corresponding to f^{(m,s)} (λ=iΔλ)(i=0, 1, . . . ) for a certain m and s while varying λ. Though described in [1.4], as λ increases, C_{f}^{(m,s)} normally decreases but changes to increase after λ exceeds the optimal value. In this base technology, λ in which C_{f}^{(m,s)} becomes the minima is defined as λₒₚₜ. As observed in FIG. 16, even if C_{f}^{(m,s)} turns to decrease again in the range λ>λₒₚₜ, the mapping will be spoiled by then and becomes meaningless. For this reason, it suffices to pay attention to the first occurring minima value. λₒₚₜ is independently determined for each submapping including f⁽ⁿ⁾.

FIG. 17 shows the behavior of the energy corresponding to f⁽ⁿ⁾(η=iΔη)(i=0, 1, . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to the object recognition, characteristic extraction, and image matching. As a result, it is possible to construct an image processing system which significantly reduces manual labors.

Some extensions to or modifications of the above-described base technology may be made as follows: (1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extrema in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as 1/E₁ and 1/E₂, may be employed. A combined evaluation equation is not necessarily a linear sum, but an n-powered sum (n=2, ½, −1, −2, etc.), a polynomial or an arbitrary function may be employed when appropriate.

The system may employ a single parameter such as the above α, two parameters such as η and λ in the base technology or more than two parameters. When there are more than three parameters used, they are determined while changing one at a time.

(2) In the base technology, a parameter is determined in such a manner that a point at which the evaluation equation C_{f}^{(m,s)} constituting the combined evaluation equation takes the minima is detected after the mapping such that the value of the combined evaluation equation becomes minimum is determined. However, instead of this two-step processing, a parameter may be effectively determined, as the case may be, in a manner such that the minimum value of a combined evaluation equation becomes minimum. In that case, αE₀+βE₁, for instance, may be taken up as the combined evaluation equation, where α+β=1 is imposed as a constraint so as to equally treat each evaluation equation. The essence of automatic determination of a parameter boils down to determining the parameter such that the energy becomes minimum.

(3) In the base technology, four types of submappings related to four types of critical points are generated at each level of resolution. However, one, two, or three types among the four types may be selectively used. For instance, if there exists only one bright point in an image, generation of hierarchical images based solely on f^{(m, 3)} related to a maxima point can be effective to a certain degree. In this case, no other submapping is necessary at the same level, thus the amount of computation relative on s is effectively reduced.

(4) In the base technology, as the level of resolution of an image advances by one through a critical point filter, the number of pixels becomes ¼. However, it is possible to suppose that one block consists of 3×3 pixels and critical points are searched in this 3×3 block, then the number of pixels will be 1/9 as the level advances by one.

(5) When the source and the destination images are color images, they are first converted to monochrome images, and the mappings are then computed. The source color images are then transformed by using the mappings thus obtained as a result thereof. As one of other methods, the submappings may be computed regarding each RGB component.

### Embodiment Related to Image Encoding and Decoding

A specific description will now be given of the image processing technology of the embodiments which uses the base technology described above.

### First Embodiment

FIG. 18 shows the overall structure of an example of an image processing system 10. In the image processing system 10, a producer PC 14 (PC: personal computer); a server 16 and a viewer PC 18 are connected to a network 12 such as the Internet, a local area network (LAN) or a wide area network (WAN).

The producer PC 14 is a PC used by a producer of web pages published on the network 12. The server 16 publishes web pages produced by using the producer PC 14. The viewer PC 18 is a PC used by a viewer of web pages published on the network 12. The viewer PC 18 may be an apparatus of another type such as a cell phone capable of viewing web pages.

FIG. 19 is a functional block diagram of the producer PC 14 according to the first embodiment. The producer PC 14 is provided with an image input unit 20, a matching processor 22, a stream generation unit 24, a communication unit 26, an inspection unit 28 and an UI 30. The producer PC 14 is provided with hardware such as a CPU, a hard disk, a RAM and a ROM. A program for producing web pages and an image encoding program for displaying images in the form of animation are installed in the producer PC 14. FIG. 19 depicts the functional block implemented by coordination of the hardware and software. Thus, the functional blocks can be implemented by a variety of forms by combination of the hardware and software.

The image input unit 20 acquires key frame. More specifically, the image input unit 20 acquires key frames stored in a memory such as a RAM or a hard disk provided in the producer PC 14.

The matching processor 22 computes corresponding points in the key frames according to the base technology. The stream generation unit 24 generates an encoded data stream by incorporating the key frames and corresponding point information. The viewer PC 18 transmits the encoded data stream over the network 12. As described, the producer PC 14 functions as an image encoding apparatus for encoding an image by performing an image matching process. The inspection unit 28 inspects the corresponding point information so as to determine whether the amount of variation between the key frames is large. The UI 130 acknowledges a user request regarding image processing.

Preparing a plurality of pairs of key frames for display of a plurality of pieces of animation on a web page to be published may require intense labor on the part of a web page producer and impose a load on an apparatus. This is addressed by the embodiment by preparing a form for accommodating key frames. With the use of this form, a plurality of pieces of animation are arranged on a web page etc.

A form for accommodating key frames, such as a key frame form 74, is prepared by image matching software installed in the producer PC 14. The storage area of the server 16 also stores a form for key frames. The producer performing a matching process on images is capable of accessing a web page in the server 16 so as to download the form for key frames to the producer PC 14.

An example of a key frame form is shown in FIG. 20A. A key frame form 74 has the shape of a horizontally elongated rectangle. Within the key frame form 74 are horizontally arranged a first image area 76, a second image area 78 and a third image area 80 (hereinafter, these areas will be generically referred to as “image areas” as needed) which are rectangularly shaped. Each of the image areas is arranged so that a predetermined interval greater than zero is provided between the periphery of the key frame form 74 and the image area. Each of the image areas is arranged so that a predetermined interval greater than zero is provided between the image areas. In the key frame form 74, these image areas are of the same shape and size. The key frame form 74 as illustrated is by way of example only. Various key frame forms with different shapes and sizes of key frame forms and different shapes, sizes and numbers of image areas are prepared.

The producer places still images in respective image areas provided in the key frame form 74. For example, as shown in FIG. 20B, the producer places the first image 68 in the first image area 76, places the second image 69 in the second image area 78 and places the third image 70 in the third image area 80. In this way, a seventh key frame 82 is prepared as a single image in which a plurality of still images are placed. Further, as shown in FIG. 20C, the producer may place the fourth image 71 in the first image area 76, places the fifth image 72 in the second image area 78 and places the sixth image 73 in the third image area 80. In this way, an eighth key frame 84 is prepared as a single image in which a plurality of still images are placed.

By placing still images in each of the seventh key frame 82 and the eighth key frame 84, intervals are respectively provided between the still images included in the seventh key frame 82 and the eighth key frame 84. The intervals between the still images provided at the periphery of the images thus arranged constitute backgrounds for the plurality of still images and function as image separation areas separating the still images.

The producer selects or creates a key frame form according to the still images arranged so that the dominant pixel value in the interval differs by a threshold or more from the dominant pixel value at the periphery of the first image 68 through the sixth image 73. As the image input unit 20 acquires the seventh key frame 82 and the eighth key frame 84, the matching processor 22 computes corresponding points in the seventh key frame 82 and the eighth key frame 84 by using the base technology.

As indicated by equation (49), the base technology identifies corresponding points by using pixel values and pixel positions. By providing an interval between images, it is ensured that an image in which a corresponding point should be identified is separated from another image. The interval also provides an area with different pixel values between an image in which a corresponding point should be identified and another image. Thus, the likelihood that a corresponding point is identified in the another image and corresponding point information is accordingly generated is reduced. Corresponding points in corresponding still image can be accurately determined by computation.

The producer can create his or her own version of frame for accommodating key frames. In this case, the producer place image areas so that a predetermined interval greater than zero is provided between the image areas. In this case, the image areas may be placed so that a predetermined interval greater than zero is provided between the periphery of the key frame form 74 and the image area.

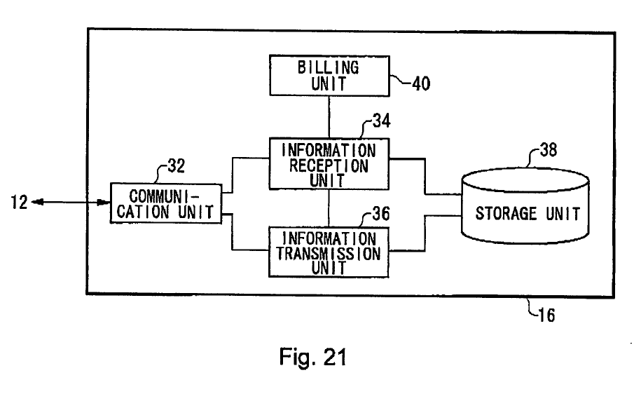

FIG. 21 is a functional block diagram of the server 16 according to the first embodiment. The server 16 is provided with a communication unit 32, an information reception unit 34, an information transmission unit 36, a storage unit 38 and a billing unit 40. The server 16 is also provided with hardware such as a CPU, a hard disk, a RAM and a ROM. FIG. 21 depicts the functional block implemented by coordination of the hardware and software. Thus, the functional blocks can be implemented by a variety of forms by combination of the hardware and software.

The information reception unit 34 receives via the communication unit 32 the encoded data stream transmitted from an external source such as the producer PC 14 via the network 12. The information reception unit 34 receives web page information for displaying a source image and a destination image, which are included in the encoded data stream, from an external source via the network 12. The storage unit 38 stores the encoded data stream and the web page information thus received. The server 16 uses the web page information thus stored to publish the web page on the network 12 for public view.

The information reception unit 34 also requests transmission of the encoded data stream which includes web page information on the published web page designated by the viewer PC 18 etc. via the network 12, by using, for example, a uniform resource locator (URL), and which also includes information on the source image and the destination image displayed on the web page. Upon receipt of the request for transmission, the information transmission unit 36 transmits the web page information and the encoded data stream to the source of the request via the communication unit 32.

Upon each reception of the encoded data stream from an external source, the billing unit 40 records the reception as a basis for billing. More specifically, the billing unit 40 records the step whereby the producer PC 14 computes image matching between two key frames as a basis for a single billing process. In other words, the billing unit 40 collects bills from the producer PC which generates encoded data streams, in accordance with the number of encoded data streams stored in the storage unit 38. By performing a billing process as described, image encoding processes are properly billed. Thus, the server 16 not only functions as an information delivery apparatus which delivers an encoded data stream to a source of request in response to an external request but also functions as a billing apparatus which bills for the generation of encoded data stream.

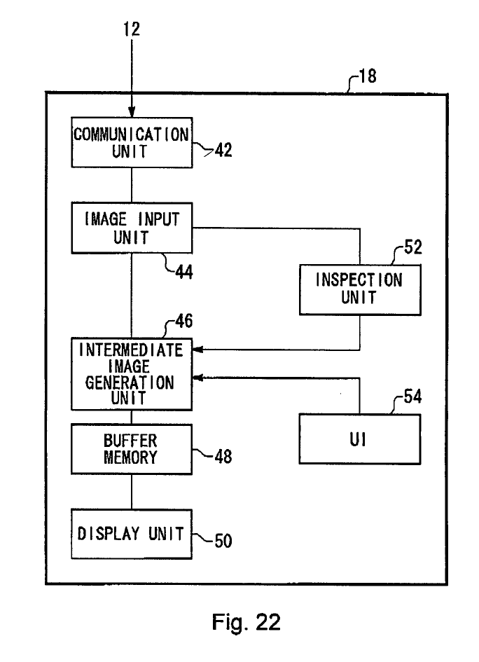

FIG. 22 is a functional block diagram of the viewer PC 18 according to the first embodiment. The viewer PC 18 is provided with a communication unit 42, an image input unit 44, an intermediate image generation unit 46, a buffer memory 48, a display unit 50, an inspection unit 52, and an VI 54. The viewer PC 18 is also provided with hardware such as a CPU, a hard disk, a RAM and a ROM. A program for displaying web pages and an image decoding program for displaying images in the form of animation are installed in the viewer PC 18. FIG. 22 depicts the functional block implemented by coordination of the hardware and software. Thus, the functional blocks can be implemented by a variety of forms by combination of the hardware and software.

The operator at the viewer PC 18 transmits a request for transmission of web page information and an encoded stream by designating a URL of a web page in the server 16. In association with the request for transmission, the communication unit 42 receives the web page information and the encoded stream transmitted from the server 16. The image input unit 44 acquires the received encoded stream. The intermediate image generation unit 46 generates intermediate frames by interpolation, based on key frame data and corresponding point information included in the encoded stream. The buffer memory 48 is used as a work area when the intermediate image generation unit 46 generates intermediate images and is also used for controlling the timing of image output. The inspection unit 52 detects the corresponding point information in the encoded stream acquired by the image input unit 44 so as to verify the amount of variation between key frames. The UI 54 acknowledges a user instruction related to image reproduction. Thus the viewer PC 18 functions as an image decoding apparatus for decoding the received encoded stream.

In displaying the web page with the designated URL, the display unit 50 displays the image ultimately obtained by using the encoded stream. More specifically, where the seventh key frame 82 and the eighth key frame 84 are placed in the web page, animations are displayed such that the flower comes into bloom gradually in the left of the page, the airplane flies higher and higher in the middle, and the automobile runs from right to left in the right.

By displaying the animation using the key frames shown in FIGS. 20B and 20C, the same visual effect is delivered to the viewer of the web page, while a smaller number of key frames is used as compared to a case where the animation is displayed using the plurality of key frames shown in FIGS. 25A and 25B. Thus, the labor of an individual who produces key frames is reduced, or the processing load on the producer PC 14 in performing a matching process is reduced. Further, the bill to be collected by the billing unit 40 is reduced, while the same visual effect is delivered to the viewer of the web page.

### Second Embodiment

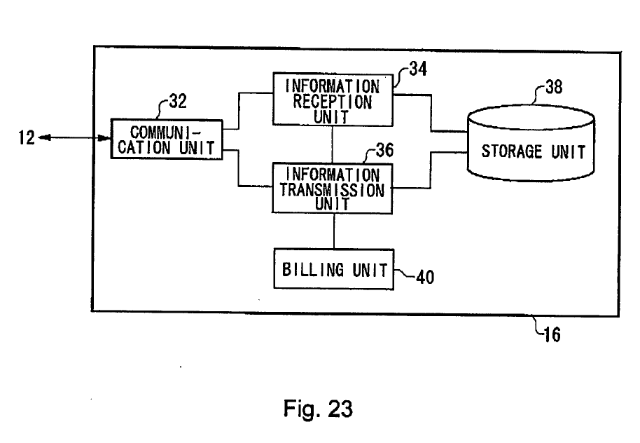

FIG. 23 is a functional block diagram of the server 16 according to a second embodiment. The other constituting elements of the image processing system 10 remain the same as those of the first embodiment. Like the server 16 according to the first embodiment, the server 16 according to the second embodiment is provided with the communication unit 32, the information reception unit 34, the information transmission unit 36 and the storage unit 38.

Like the server 16 according to the first embodiment, the server 16 according to the second embodiment is also provided with the billing unit 40. The billing unit 40 of the server 16 according to the second embodiment performs a billing process such that the source of generation of an encoded stream is billed each time the information transmission unit 36 transmits an encoded stream to an external destination. In this way, the process for decoding an encoded stream is properly billed.

### Third Embodiment

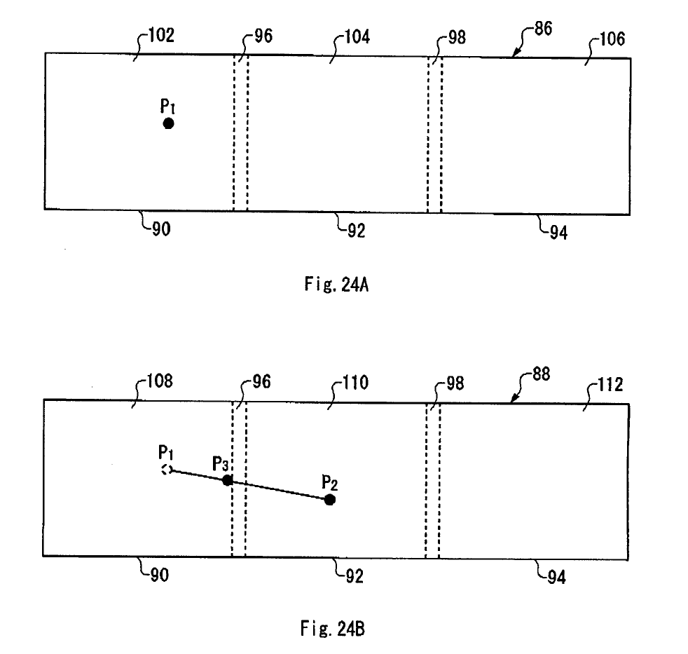

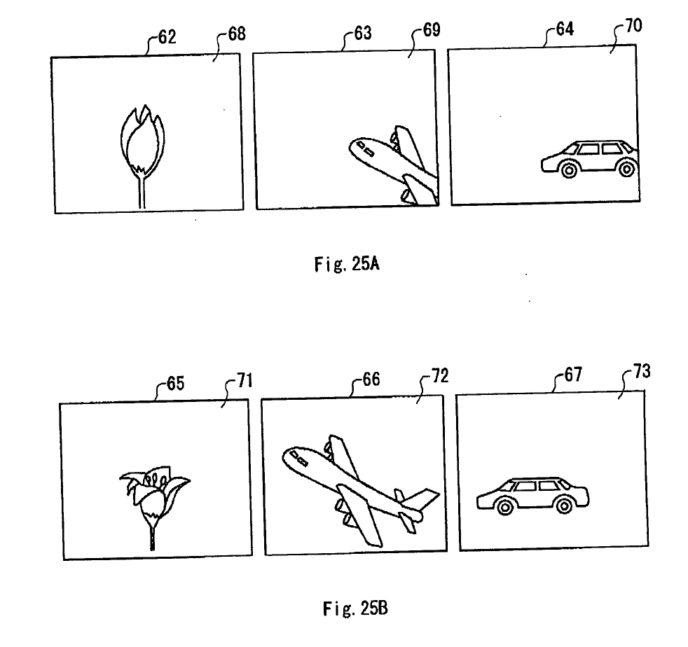

The constituting elements of the image processing system 10 according to a third embodiment are the same as those of the first embodiment. The matching processor 22 of the producer PC 14 according to the third embodiment is provided with a correction unit (not shown) for correcting corresponding point information in the event that the corresponding information generated is not proper. The process of the correction unit will be described with reference to FIGS. 24A and 243.

FIG. 24A shows a ninth key frame 86, which is a source image, and FIG. 24B shows a tenth key frame 88, which is a destination image. The ninth key frame 86 is formed as a horizontally elongated rectangle.

The ninth key frame 86 is provided with a first image area 90, a second image area 92 and a third image area 94, the image areas being arranged in the stated order from left to right. These image areas are formed as rectangles having the same shape and size. A vertically elongated image separation area 96 is provided between the first image area 90 and the second image area 92 so as to separate the two areas. There is also provided a vertically elongated image separation area 98 between the second image area 92 and the third image area 94 so as to separate the two areas. A first image 102 is placed in the first image area 90, a second image 104 is placed in the second image area 92 and a third image area 106 is placed in the third image area 94. Each of the images has the same shape and size as those of the image area in which it is placed.

Like the ninth key frame 86, the tenth key frame 88 is provided with the first image area 90, the second image area 92, the third image area 94, the image separation area 96 and the image separation area 98. In the tenth key frame 88, a fourth image 108 is placed in the first image area 90, a fifth image 110 is placed in the second image area 92 and a sixth image 112 is placed in the third image area 94. Each of the images in the tenth key frame also has the same shape and size as those of the image area in which it is placed.

It will now be assumed, for example, that a point P2 in the fifth image 110 is identified to correspond to a starting point P1 in the first image 102. Since the first image 102 corresponds to the fourth image 108, the point corresponding to the starting point in the first image 102 should be identified in the fourth image 108.

The correction unit of the matching processor 22 compares the position of the corresponding point identified and the corresponding image area so as to determine whether the corresponding point is identified in the corresponding image. In the case of FIG. 24B, a determination is made as to whether the corresponding point is identified in the fourth image 108. If, as shown in FIG. 24B, the corresponding point is identified in the fifth image 110 instead of the fourth image 108, which is the corresponding image, the correction unit marks a point in the fourth image 108 located at the same position as the starting point P1 and then draws a line connecting that point and the corresponding point P2. The correction unit computes the position of the point of intersection between the line and the periphery of the fourth image 108 and identifies the intersecting point thus determines as the corresponding point P3. In the following steps, the matching processor 22 identifies accurate corresponding points by using the same method as used in the base technology, so as to create corresponding point information. Thus, the correction unit operates to prevent corresponding points from being created in images other those correspond to each other.

Image encoding and image decoding are described above. As in the case of encoding, the apparatus functions as an image editing tool by providing user interaction. The embodiments are by way of example only and various variations are possible. Some such variations will be given below.

The producer PC14 may have the function of the server 16. With this, the producer PC14 is capable of producing and delivering an encoded stream.

Referring to FIGS. 24A and 24B, the correction unit may identify a point in the fourth image 108 located at a position corresponding to that of the start point P1, instead of identifying the corresponding point P3. In the following steps, the matching processor 22 identifies accurate corresponding points by using the same method as used in the base technology, so as to create corresponding point information. This approach is equally capable of preventing corresponding points from being created in images other those correspond to each other.

What is claimed is:

1. An image encoding method comprising:
acquiring a first key frame formed as a single image comprising an arrangement of a plurality of still images, and a second key frame formed as a single image comprising an arrangement of a plurality of still images respectively corresponding in position to the plurality of still images in the first key frame;
acquiring corresponding point information related to corresponding points in the first key frame and the second key frame by subjecting the frames to an image matching process; and
outputting the first key frame, the second key frame and the corresponding point information as encoded data.

2. The image encoding method according to claim 1, wherein
a predetermined image separation area is provided between the plurality of still images included in each of the first and second key frames.

3. The image encoding method according to claim 2, wherein
the image separation area constitutes a background area for the plurality of still images.

4. The image encoding method according to claim 1, wherein
a dominant pixel value in the background area differs from each of dominant pixel values in a predetermined area in each of the plurality of still images placed in the background area, by a predetermined threshold or more.

5. The image encoding method according to claim 2, wherein
a dominant pixel value in the background area differs from each of dominant pixel values in a predetermined area in each of the plurality of still images placed in the background area, by a predetermined threshold or more.

6. The image encoding method according to claim 1, further comprising:
recording the subjecting as a basis for a single billing process.

7. The image encoding method according to claim 2, further comprising:
recording the subjecting as a basis for a single billing process.

8. An image encoding apparatus comprising:
an image input unit which acquires a first key frame formed as a single image comprising an arrangement of a plurality of still images, and a second key frame formed as a single image comprising an arrangement of a plurality of still images respectively corresponding in position to the plurality of still images in the first key frame;
a matching processor which acquires corresponding point information related to corresponding points in the first key frame and the second key frame by subjecting the frames to an image matching process; and
a stream generation unit which outputs the first key frame, the second key frame and the corresponding point information as encoded data.
